(19) United States
(12) Patent Application Publication
(10) Pub. No.: US 2005/0259249 A1
(43) Pub. Date: Nov. 24, 2005

(54) Nonlinear optical detection of fast cellular electrical activity

(76) Inventors: Daniel A. Dombeck, Ithaca, NY (US); Watt W. Webb, Ithaca, NY (US); Mireille Blanchard-Desce, Rennes (FR); Olivier Mongin, Rennes (FR); Thomas Mallegol, Montgermont (FR)

Correspondence Address: Michael L. Goldman, Esq.;Nixon Peabody LLP, Clinton Square, P.O. Box 31051, Rochester, NY, 14603-1051, US

(21) Appl. No.: 11/044,889

(22) Filed: Jan. 27, 2005

Related U.S. Application Data
(60) Provisional application No. 60/539,380, filed on Jan. 27, 2004.

(51) Int. Cl. G01J 3/00

(52) U.S. Cl. 356/300

(57) ABSTRACT

The present invention is directed to various methods involving nonlinear microscopy and dyes that are sensitive to fast cellular membrane potential signals and capable of generating nonlinear optical signals. The present invention includes methods of producing high spatiotemporal resolution images of electrical activity in cellular tissue, as well as methods of detecting and investigating disease within a particular cellular tissue of a living organism. The present invention further relates to methods of detecting membrane potential signal changes in a neuron or a part of a neuron, as well as in a population of cells.

This application claims the benefit of U.S. Provisional Patent Application Ser. No. 60/539,380, filed Jan. 27, 2004.

The subject matter of this application was made with support from the United States Government under National Institutes of Health (“NIH”) Grant No. GM08267, NIH Grant No. GM07469, N1H-NIBB Grant No. 9 P41 EB001976-17, and Defense Advanced Research Projects Agency (“DARPA”) Grant No. MDA972-00-1-0021. The U.S. Government may have certain rights.

### FIELD OF THE INVENTION

The present invention relates to various methods involving nonlinear microscopy and dyes that are sensitive to fast cellular membrane potential signals and capable of generating nonlinear optical signals.

### BACKGROUND OF THE INVENTION

The investigation of the electrical signaling properties of excitable cells, such as neurons, is predominately accomplished through the use of intracellular microelectrodes. Though these studies are useful for obtaining temporal electrical activity from a few locations on a single neuron (Stuart et al., “Active Propagation of Somatic Action Potentials into Neocortical Pyramidal Cell Dendrites,” Nature 367:69-72 (1994)), they reveal little about the spatiotemporal modulations of membrane potential (Vₘ) over the entire cell or the activity of a population of neurons. Optical methods for monitoring Vₘ enable a greater understanding of the mechanisms underlying single neuron firing properties and cooperative electrical signaling in groups of neurons.

It is currently possible to follow cellular Vₘ activity optically through the use of linear one-photon methods (i.e., fluorescence, absorption, scattering, and birefringence). Slow transmembrane redistribution of dyes allows for Vₘ imaging with high signal-to-noise ratio (S/N), but cannot provide the 1 ms temporal resolution needed to record fast Vₘ signals (Rink et al., “Lymphocyte Membrane Potential Assessed with Fluorescent Probes,” Biochim Biophys Acta 595:15-30 (1980)). Elegant green fluorescent protein constructs (Knopfel et al., “Optical Recordings of Membrane Potential Using Genetically Targeted Voltage-Sensitive Fluorescent Proteins,” Methods 30:42-48 (2003)) and fluorescence resonance energy transfer pairs (Gonzalez et al., “Improved Indicators of Cell Membrane Potential that use Fluorescence Resonance Energy Transfer,” Chem Biol 4:269-277 (1997)) have been employed to record Vₘ, but are limited either in their response time or ability to stain intact tissue (Zochowski et al., “Imaging Membrane Potential with Voltage-Sensitive Dyes,” Biol Bull 198:1-21 (2000)), respectively. Faster methods employing intrinsic changes in linear scattering or birefringence have been used to record action potentials (“APs”) in thin specimens (Cohen et al., “Light Scattering and Birefringence Changes During Nerve Activity,” Nature 218:438-441 (1968); Stepnoski et al., “Noninvasive Detection of Changes in Membrane Potential in Cultured Neurons by Light Scattering,” Proc Nat'l Acad Sci USA 88:9382-9386 (1991)), but recent attention has focused on fluorescent probes. These fast probes can respond to a Vₘ change of 100 mV with up to 10-20% changes in fluorescence emission (Grinvald et al., “Improved Fluorescent Probes for the Measurement of Rapid Changes in Membrane Potential,” Biophys J 39:301-308 (1982); Loew et al., “A Naphthyl Analog of the Aminostyryl Pyridinium Class of Potentiometric Membrane Dyes Shows Consistent Sensitivity in a Variety of Tissue, Cell, and Model Membrane Preparations,” J Membr Biol 130:1-10 (1992); Rohr et al., “Multiple Site Optical Recording of Transmembrane Voltage (MSORTV) in Patterned Growth Heart Cell Cultures: Assessing Electrical Behavior, with Microsecond Resolution, on a Cellular and Subcellular Scale,” Biophys J 67:1301-1315 (1994)), though the response is typically limited to ˜1% in practice (Zochowski et al., “Imaging Membrane Potential with Voltage-Sensitive Dyes,” Biol Bull 198: 1-21 (2000)).

An innovative combination of high dye concentration, large illumination intensities, large collection areas and/or very sensitive light detectors has allowed researchers to overcome these small signal changes and to image APs with a S/N of ˜10 and sub-threshold events by temporal averaging at a spatiotemporal resolution of ˜10 μm and <1 ms (Zochowski et al., “Imaging Membrane Potential with Voltage-Sensitive Dyes,” Biol Bull 198:1-21 (2000)). However, in thick preparations high-resolution one-photon techniques are limited to imaging depths of <˜50 μm by light scattering, making the poor spatial resolution deep in scattering tissues (such as neural tissue) the most severe limitation. Additionally, previous methods are limited by a background signal from dye not bound to the plasma membrane that reduces the effective observed dye response to membrane potential and complicates the optical quantification of membrane potential changes. To date, there has been no demonstration of the ability to record fast Vₘ activity in living cells with any form of nonlinear microscopy and therefore ˜1 ms, high spatial resolution optical Vₘ recording has been limited to thin preparations or superficial regions of thick specimens. Previous quantitative methods have also been limited to culture dish preparations where background signals can be kept to a minimum, making deep tissue optical quantification of membrane potential unattainable. Thus, there is a need to develop imaging techniques that can overcome these deficiencies in the art.

Microtubules (“MTs”) are a major cytoskeletal element of neuronal cell processes and are responsible for structural support and for active intracellular transport. MTs exhibit an intrinsic axial polarity, defined by different + and −ends, giving an overall non-inversion symmetric structure. This polarity determines the self-assembly characteristics of the MT polymer from its tubulin subunits (Bergen et al., J Cell Biol 84:141-150 (1980); Binder et al., Proc Nat'l Acad Sci USA 72:1122-1126 (1975)) and the directionality of vesicle and organelle movements via the uni-directional molecular motors (Baas, P. W., Neuron 22:23-31 (1999)). The MT ensemble polarity has been implicated in determining the unique morphological and compositional features of axons and dendrites in culture (Baas, P. W., Micro Res Tech 48:75-84 (2000)).

Research on the role of MT ensemble polarity in the dynamical development of neuronal processes, growth cones and injury response has been hindered by the lack of suitable techniques. The only previous technique capable of determining MT polarity is the elegant electron microscopy (EM) “hook method” (Heidemann et al., Meth Cell Biol 24:207-216 (1982); Heidemann et al., Nature 286:517-519 (1980)) in thin fixed sections. There is a need to develop a non-invasive imaging modality for thick living tissue (˜300400 μm imaging depth) that is capable of recording MT ensemble polarity information.

The present invention is directed to overcoming these and other deficiencies in the art.

### SUMMARY OF THE INVENTION

The present invention relates to a method of producing a high spatiotemporal resolution image of electrical activity in cellular tissue. This method involves staining the cellular tissue with a dye that is sensitive to fast cellular membrane potential signals and capable of generating nonlinear optical signals. This method further involves optically imaging fast cellular membrane potential signals in the cellular tissue by using nonlinear microscopy to produce a high spatiotemporal resolution image of electrical activity in the cellular tissue.

The present invention also relates to a method of detecting and investigating disease within a particular cellular tissue of a living organism. This method involves providing a sample of cellular tissue of a living organism. The sample of cellular tissue is stained with a dye that is sensitive to fast cellular membrane potential signals and capable of generating nonlinear optical signals. Fast cellular membrane potential signals in the sample of cellular tissue are optically recorded by using nonlinear microscopy to produce a high spatiotemporal resolution image of electrical activity in the sample of cellular tissue. The optically recorded fast cellular membrane potential signals in the sample of cellular tissue are compared to those in healthy cellular tissue of the living organism subjected to similar conditions. The method further involves identifying as potentially diseased any sample of cellular tissue that generates different fast cellular membrane potential signals than that of the healthy cellular tissue under similar conditions.

The present invention also relates to a method of detecting membrane potential signal changes in a neuron or in a part of a neuron. This method involves providing a neuron or a part of a neuron. The neuron or part of a neuron is stained with a dye that is sensitive to fast cellular membrane potential signals and capable of generating nonlinear optical signals. The membrane potential signals in the neuron or in the part of the neuron are optically recorded using nonlinear microscopy to produce a high spatiotemporal resolution recording of electrical activity in the neuron or in the part of the neuron. Changes of the membrane potential signals in the neuron or in the part of the neuron are then determined.

The present invention further relates to a method of detecting membrane potential signal changes in a population of cells. This method involves providing a population of cells including at least two cells from a living organism. The population of cells is stained with a dye that is sensitive to fast cellular membrane potential signals and capable of generating nonlinear optical signals. The membrane potential signals in the population of cells are optically recorded using nonlinear microscopy to produce a high spatiotemporal resolution recording of electrical activity in the population of cells. Changes of the membrane potential signals in the population of cells are then determined.

Membrane potential signals (and their propagation) are the primary means by which communication between many types of cells takes place in living things, e.g., neurons communicating with each other to form thoughts, muscle cells generating concerted movements, etc. Changes in membrane potential signals refer to any change in the voltage difference between the two opposing surfaces of a lipid membrane. These membrane potential changes are important in generating these events. The present invention is useful in elucidating how these events are generated by observing the membrane potential changes deep in tissue with high resolution. Membrane potential signal propagation refers to the spread of membrane potential signal changes across the surface of a membrane as a means of sending a signal from one part of a cell to another part of a cell or from one cell in a network to another cell in the network.

The methods of the present invention are effective in studying neurons, parts of neurons (e.g., axons, dendrites, etc.), and other types of cellular tissue (e.g., microtubules). For example, axons contain like-polarity microtubule ensembles, but dendrites contain mixed-polarity microtubule ensembles. Because second harmonic generation imaging reveals regions of like-polarity microtubule ensembles and not mixed-polarity regions, the methods of the present invention can be used to locate single axons of neurons or axon-rich areas in the cellular tissue. Membrane potential signals can vary significantly between axons and dendrites; therefore, the ability to locate these regions with second harmonic generation and then image the membrane potential on the specific region should prove useful.

The techniques used in the methods of the present invention allow optical detection of fast (i.e., <1 millisecond) cellular electrical signals of biological cells by using nonlinear microscopy based on second-harmonic generation. The method of the present invention represents the first nonlinear method to achieve the necessary spatial and temporal resolution to enable visualization of these electrical cellular signals. The optical second-harmonic generation signal arises from the membranes of cells stained with a special class of dyes (defined by the dyes (all-E)-4-[10-[4-(dibutylamino)phenyl]-3,8-dimethyl-1,3,5,7,9-decapentaenyl]-1-(4-sulfobutyl)pyridinium, inner salt (“Molecule A”), 4-[[4-(dihexylamino)phenyl]ethynyl]-1-(4-sulfobutyl)pyridinium, inner salt (“Molecule B”), N-(3-triethylammoniumpropyl)-4-(6-(4-(diethylamino)phenyl)hexatrienyl)pyridinium dibromide (“FM 4-64”), and their derivatives). The spatial resolution of 0.6 microns that has been demonstrated by the present invention represents the highest yet achieved for recording fast cellular signals by any membrane potential imaging technique, but can likely be increased. The fast timescale was achieved by combining previous second-harmonic generation imaging methods with the much faster line scanning method. In order to increase the signal-to-noise ratio, many line scans need to be averaged. This necessitated the use of an additional development for eliciting temporally stable action potentials that obviated the need for data post-processing; however, it is also possible to post-process the data to avoid this special elicitation procedure.

Due to the molecular alignment requirement of SHG, the present invention has the advantage over all other techniques (including fluorescence, light scattering, birefringence, absorption, etc.) in that the effective response to membrane potential is not attenuated by any background. This allows for an increased signal to noise ratio compared to other techniques that have a similar response to membrane potential, but are adversely affected by background signals. Additionally, this background limits the ability of other techniques to optically quantify the membrane potential. Because SHG is not affected by background, the signal is quantifiable and can be directly related to changes in membrane potential. This ability to optically quantify membrane potential signals deep in scatting tissue has never been demonstrated before (on any spatiotemporal scale).

The present invention has a number of characteristics that are more advantageous than previously known imaging techniques. For example, the present invention uses changes in second-harmonic generation from a special class of dyes (Molecule A, Molecule B, FM 4-64 and their derivatives) in live cells. The special class of dyes of the present invention can be used in excitable cells (including neurons) during electrical activity. The present invention can be used to record the second-harmonic signal at the necessary temporal resolution (full line scan time of 0.833 milliseconds, and 10 microseconds recording time per measured membrane) to study fast signals, including resolving action potentials, and sub-threshold events. This time scale can be generalized from 1 microsecond to minutes resolution. Other characteristics exhibited by the method of the present invention include, for example, the following: (1) the highest spatial resolution yet achieved for fast membrane potential imaging in live cells with the potential for resolutions <0.1 microns; (2) controllable phototoxicity during recording; (3) the first nonlinear method to record fast cellular electrical signals (including action potentials); (4) no background signal from dye molecules not responding to membrane potential; (5) a single optical signal whose relative intensity change can be quantitatively related to membrane potential changes; and (6) the ability to image hundreds of microns deep in scattering tissue.

The nonlinear technique of the present invention can also be useful for recording fast cellular signals (such as action potentials) with high-resolution deep in scattering tissue where linear methods are not applicable. This will allow for the investigation of how the brain is “wired,” in intact tissue with unprecedented resolution and depth penetration. Specifically, the technique can access the membrane potential of small structures such as dendritic spines, which have eluded electrical investigation due to their size, and detect the interconnections of neural processing circuits. Research on diseased states of the nervous system, such as Alzheimer's disease, will also benefit from this technique by the now possible study of electrical dysfunction of axons and dendrites around brain plaques and tangles. This technique is not limited to the above applications and will likely be applicable to many more.

The present invention may also be used for more general applications, including, for example, the following: (1) investigate dye derivatives in this class that should be brighter (larger beta value) and have a larger sensitivity to membrane potential changes in order to avoid the need for signal averaging; (2) illuminate dye derivatives at longer wavelengths to match their resonant frequencies, increase the brightness and sensitivity to membrane potential, and reduce photodamage caused by intrinsic tissue absorption at shorter wavelengths; (3) increase the concentration of dye to increase the second-harmonic signal and to avoid the need for signal averaging; (4) combine with faster whole-frame imaging methods; (5) combine with uniform polarity microtubule second-harmonic signal to identify neurites absolutely as axons or dendrites; (6) intracellularly fill cells with second-harmonic generation membrane dyes with patch pipettes and use in vivo or ex vivo; (7) combine with two-photon fluorescence signal from dyes to increase the signal-to-noise ratio; (8) combine with methods that reduce phototoxicity, such as reducing the oxygen tension or adding free radical scavengers, in order to increase the excitation intensity and therefore the signal-to-noise ratio; (9) combine with two-photon fluorescence signals from ion indicators such as calcium and sodium probes; (10) increasing the spatial resolution two- or three-fold; (11) stain and record membrane potential signals from large populations of neurons; and (12) using the backward propagating SHG signal to image in vivo.

### BRIEF DESCRIPTION OF THE DRAWINGS

The patent or application file contains at least one drawing executed in color. Copies of this patent or patent application publication with color drawings will be provided by the U.S. Patent and Trademark Office upon request and payment of the necessary fee.

FIG. 1 is a schematic drawing demonstrating two-photon fluorescence (“TPF”) and second-harmonic generation (“SHG”) microscope. SHG and TPF images are simultaneously recorded. The key elements of the excitation are a pulsed Ti:Sapphire laser (TS) operated between 760 and 880 nm, a Berek polarization compensator (BC), a scan box (XYS), and a focusing objective (FO) (0.45-1.3 NA). For collection, TPF is epi-collected from the sample (S) and split into appropriate wavelength channels with dichroic mirrors (DM) and emission filters (EF). The predominately forward propagating SHG is collected in the transmitted light direction with a dipping objective (DO) (0.95 NA) and a plano-convex lens (L) and separated from the excitation and fluorescence light through the use of band pass and blue glass filters (F). Bialkali PMT (PMT) detectors are connected to a PC for acquisition (the SHG PMT signal is amplified before acquisition). Red represents the illumination laser, green represents the two photon fluorescence signal, and blue represents the second harmonic generation signal.

FIGS. 2A-2G are images of hippocampal brain slices using SHG and immunohistochemistry. FIG. 2A shows SHG from an acute slice. This mosaic is formed by 10 images, each a projection of 3 optical z-sections taken ˜30 μm apart. The dense mossy fiber axon bundle between the DG and CA3 is clearly seen. FIG. 2B is a zoom of CA3 region of FIG. 2A and shows individual axons emanating from the pyramidal neurons (arrowheads). Circularly polarized excitation at 880 nm with average laser intensity (<I>)=˜16.3 MW/cm² (w=0.44 μm, where w is the two-photon radial beam waist). Scale bars=200 μm (in FIG. 2A), 100 μm (in FIG. 2B). FIGS. 2C-2E (of the bottom row) show confocal images of fixed sections immunostained for tau, MAP2, and β-tubulin respectively (no SHG was seen with confocal imaging). The tau and SHG morphology is similar (arrows) whereas the MAP2 and SHG are not. This suggests an axonal origin of the SHG. Similarly, magnified regions of CA3 stained for axonal neurofilaments (FIG. 2F) and MAP2 (FIG. 2G) reveal that the individual processes seen in FIG. 2B are axons (arrowheads in FIG. 2F). FIGS. 2A, 2C, 2D, and 2E show different slices. Scale bars=400 μm (in FIGS. 2C-2E), 100 μm (in FIGS. 2F-2G).

FIGS. 3A-3B are SHG micrographs showing primary hippocampal neuron cultures at two weeks. As shown in FIG. 3A, green pseudo-color is SHG, while red pseudo-color is intrinsic fluorescence. FIG. 3B shows the same location as in FIG. 3A, but cultures in FIG. 3B are fixed and doubly immunostained for MAP2 (red) and tau (green); yellow is a colocalization of MAP2 and tau (no SHG or intrinsic fluorescence signal is present). Because tau marks axons, it is clear that the SHG emanates from axons (white arrows). Because MAP2 marks dendrites and somata, it is also clear that the SHG does not stem from either of these structures (blue arrows). FIG. 3A shows elliptically polarized excitation (white elliptical arrow) at 880 nm with <I>=˜30.0 MW/cm² (w=0.26 μm). FIG. 3B are TPF images. Excitation=780 nm. Both FIGS. 3A and 3B are projections of 16 optical z-sections taken 0.5 μm apart. Scale bars=50 μm.

FIG. 4 is a graph showing the effects of cytochalasin D and nocodazole on SHG from mossy fibers. Mean SHG from mossy fibers versus time. At 20 minutes, control, cytochalasin D, or nocodazole solutions were added. Cytochalasin D did not affect the SHG, however the effect of nocodazole is drastic, showing the dependence of SHG on MTs and not on actin. Error bars represent standard deviation of the 4 trials for each drug. 880 nm excitation with <I>=11.4 MW/cm² (w=0.44 μm).

FIGS. 5A-5B are micrographs showing non-neuronal SHG structures. FIG. 5A: SHG (green pseudo-color) is seen from mitotic spindles (orange arrows) and from interphase MT ensembles (blue arrow). Red pseudo-color is intrinsic fluorescence. Projection of 9 optical z-sections 0.5 μm apart. Horizontally polarized excitation at 880 nm with <I>=˜81.6 MW/cm² (w=0.16 μm). Scale bar=10 μm. FIG. 5B: SHG (green pseudo-color) is seen from the cilia lining the walls of the aquaductus cerebri in brain stem slices. Red pseudo-color is intrinsic fluorescence. Horizontally polarized excitation at 780 nm with <I>=31.0 MW/cm² (w=0.39 μm). Scale bar=100 μm.

FIGS. 6A-6E demonstrate spectral and polarization characterization of signal. FIG. 6A: Normalized spectra from the mossy fibers of an acute hippocampal slice show peaks always at exactly half the excitation wavelength and of similar bandwidth as the excitation, proving the SHG nature of the emission. The relative effective SHG cross-section increases as the excitation is moved to shorter wavelengths (error bars represent standard deviation of three trials at each wavelength). FIGS. 6B and 6C: DG axons from the same location, but different excitation polarizations (gray arrows). No emission analyzer was used. FIGS. 6D and 6E: Mossy fibers from the same location with the same excitation polarization (gray arrows), but different orientations of an emission analyzer (white arrows). FIGS. 6B-6E: 880 nm excitation with <I>=17.9 MW/cM² (w=0.44 μm). Scale bars=50 μm.

FIGS. 7A-7C are micrographs demonstrating that SHG should allow for following neuronal polarity development in living brain tissues. Experiments on hippocampal neurons in culture suggest it is possible to follow ensemble MT polarity development in living neurons over time. FIG. 7A shows a neuron after 5 days in culture; at this development stage, MT polarity is uniform not only in the nascent axon (blue arrow), but also the proto-processes (Baas et al., J Cell Biol 109:3085-3094 (1989), which is hereby incorporated by reference in its entirety) (i.e., orange arrow). Green pseudo-color is SHG, red pseudo-color is intrinsic fluorescence. Approximately circularly polarized excitation at 760 nm with <I>=˜109.3 MW/cm² (w=0.14 μm). FIG. 7B shows a neuron after 7 days in culture (different neuron than in FIG. 7A); at this stage in development, the MTs in dendrites (not seen in this image, but present in wide field illumination) have attained a mixed polarity but the axon (blue arrow) remains with uniform polarity MTs (Baas et al., J Cell Biol 109:3085-3094 (1989), which is hereby incorporated by reference in its entirety). Green pseudo-color is SHG, red pseudo-color is intrinsic fluorescence. Circularly polarized excitation at 800 nm with <I>=˜48.6 MW/cm² (w=0.16 μm). FIG. 7C is an image of axons funneling into the mossy fibers in the DG in an acute hippocampal slice. Similar axonal morphology is seen to that of the neuron in FIG. 7B, indicating the possibility of investigating the development of ensemble MT and neuronal polarity with SHG in vivo (or ex vivo). Green pseudo-color is SHG, red pseudo-color is intrinsic fluorescence, and the dark band is the somatic layer of the DG granular neurons. Horizontally polarized excitation at 780 nm with <I>=˜24.8 MW/cm² (w=0.39 μm). Scale bars=20 μm.

FIGS. 8A-8E demonstrate line scan recording of Vₘ with SHG during voltage steps in cultured Aplysia neurons. FIG. 8A: Projection image superimposing 21˜1 μm thick z-sections 2 μm apart. FIG. 8B: Single z-section through the neuron in FIG. 8A at the plane of line scanning. Green line represents the scanned line where membrane potentials are recorded. FIG. 8C: SHG signal changes recorded by line scanning the line denoted in FIG. 8B at 600 lines/second. The voltage clamped neuron was given a 240 ms duration −100 mV step after 80 ms of scanning during each line scan. N=50 line scans were averaged. The line scan image is scaled to visualize the small change in SHG emission. Scale bars=50 μm and 50 ms. FIG. 8D: The green trace, obtained from the left membrane line in FIG. 8C, is a normalized intensity plot of SHG emission vs. time. The red line represents the measured Vₘ during the voltage clamp step. FIG. 8E: Plot of ASHG/SHG over physiologically relevant ΔVₘ. The functional fit in red shows a linear relationship. Error bars represent standard deviation of 3-5 different measurements at each ΔVₘ±˜4 mV. Note the inverse relationship between ΔSHG/SHG and ΔVₘ.

FIGS. 9A-9D demonstrate fast SHG line scan recording of APs at multiple sites in cultured Aplysia neurons. FIG. 9A: SHG projection image of six ˜1 μm thick z-sections 3 μm apart. Green lines represent the scanned lines. Scale bar=50 μm. FIGS. 9B-9C: The green traces, obtained from the averaged line scans, are normalized intensity plots of SHG emission vs. time at membrane Position 1 and Position 2 respectively in FIG. 9A at 1200 lines/second (0.833 ms/line). Two APs were elicited by current injection (timing of current pulses given by black arrow heads), one at 45 ms and the other at 170 ms, during each line scan. N=50 line scans were averaged. The red trace is the Vₘ from the recording electrode at the soma. The inset is an expanded time base around the AP in the blue dashed box. FIG. 9C reveals the usefulness of high-resolution optical Vₘ recording by showing the clear difference in AP duration that can occur between the soma and neurites of individual neurons. FIG. 9D shows an example of shorter APs from a different neuron than FIG. 9A. N=70 line scans were averaged.

FIGS. 10A-10B demonstrate fast SHG line scan recording of action potentials at sites on neurons >˜70 microns deep in a hippocampal brain slice. FIG. 10A: Single SHG image of a neuron filled with FM 4-64 via a patch pipette. Red line represents the scanned line. Scale bar=20 μm. FIG. 1 OAi shows SHG line scan recording of action potentials elicited in neuron from FIG. 10A (n=30 line scans were averaged). FIG. 10Aii shows electrical recording of action potentials through patch pipette. FIG. 10B: Single SHG image of a neuron filled with FM 4-64 via a patch pipette. Red line represent the scanned line. Scale bar=20 μm. FIG. 10Bi: SHG line scan recording of action potentials elicited in neuron from FIG. 10B (n=55 line scans were averaged). FIG. 10Bii: Electrical recording of action potentials through patch pipette.

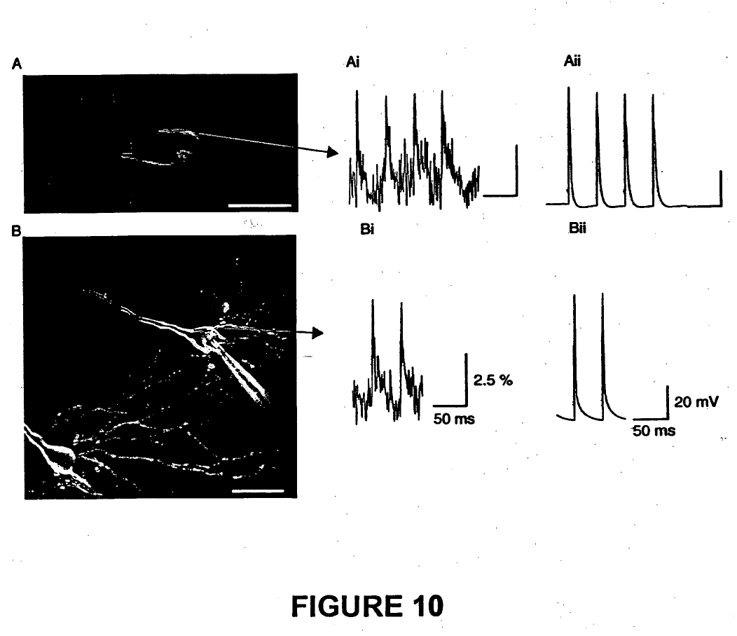

### DETAILED DESCRIPTION OF THE INVENTION

The present invention relates to a method of producing a high spatiotemporal resolution image of electrical activity in cellular tissue. This method involves staining the cellular tissue with a dye that is sensitive to fast cellular membrane potential signals and capable of generating nonlinear optical signals. This method further involves optically imaging fast cellular membrane potential signals in the cellular tissue by using nonlinear microscopy to produce a high spatiotemporal resolution image of electrical activity in the cellular tissue.

As used herein, the term “fast cellular membrane potential signals” can include, for example, action potentials, sub-threshold events, or a combination of action potentials and sub-threshold events.

In one embodiment, the nonlinear microscopy techniques used in the present invention can include second-harmonic generation microscopy. In particular, the second-harmonic generation microscopy is effective in generating a second-harmonic generation signal that emanates from the cellular tissue with less than about 5 percent background from an intracellular source or from an extracellular source. The second-harmonic generation microscopy can also be effective in generating a second-harmonic generation signal that is quantifiable and that can be directly related to changes in membrane potential. In another embodiment, the nonlinear microscopy can include third-harmonic generation microscopy, fourth-harmonic generation microscopy, and/or fifth-harmonic generation microscopy. In another embodiment, the nonlinear microscopy can involve multiphoton excitation, including, multi-photon fluorescence (e.g., two-photon fluorescence, three-photon fluorescence, etc.). In yet another embodiment, the nonlinear microscopy can involve a combination of multiphoton excitation and second-harmonic generation microscopy.

As used herein, suitable nonlinear microscopy techniques for use in the methods of the present invention are effective in producing an image having a spatiotemporal resolution that includes, for example, (i) a temporal resolution of between about 1 microsecond and about 1 minute and a spatial resolution of up to about 0.1 micron, (ii) particularly a temporal resolution of between about 1 microsecond and about 1,000 microseconds and a spatial resolution of between about 0.1 micron and about 10 microns, and (iii) more particularly a temporal resolution of between about 50 microseconds and about 1,000 microseconds and a spatial resolution of between about 0.1 micron and about 1 micron. The nonlinear microscopy technique is also effective in recording fast cellular membrane potential signals on an individual membrane of the cellular tissue at (i) a temporal resolution of between about 1 microsecond and about 1 minute and a spatial resolution of up to about 0.1 micron, (ii) particularly a temporal resolution of between about 1 microsecond and about 1,000 microseconds and a spatial resolution of between about 0.1 micron and about 10 microns, and (iii) more particularly a temporal resolution of between about 50 microseconds and about 1,000 microseconds and a spatial resolution between about 0.1 micron and about 1 micron.

Further, the suitable nonlinear microscopy techniques that are useful in the methods of the present invention can also be effective in recording changes in an image having a signal-to-noise ratio that is (i) equal to or greater than 1-to-1, (ii) particularly between about 1-to-1 and about 100-to-1, and (iii) more particularly between about 20-to-1 and about 80-to-1. The nonlinear microscopy technique is also effective in producing an image of fast cellular membrane potential signals at a depth of up to about 1 millimeter into the cellular tissue with sub-micrometer resolution.

As used herein, the term “cellular tissue” can include any type of cellular tissue from a living organism that is capable of generating electrical activity. Suitable cellular tissue can include, for example, a single cell, a plurality of cells (e.g., a population of cells), or parts of cells from a living organism, and more particularly can include, but is not limited to, neurons, membranes, microtubules, parts of such neurons, membranes, and microtubules, and combinations thereof. As used herein, a “part of a neuron” includes, for example, an axon, a dendrite, a dendritic spine, a fine dendrite, a soma, and/or subparts thereof. As used herein, the term “living organism” can include any organism belonging to any of the five kingdoms of life (i.e., the Monera, Protista, Fungi, Plantae, and Animalia kingdoms).

A suitable dye for use in the methods of the present invention can include, without limitation, a styryl dye. Suitable styryl dyes can include, for example, 4-[[4-(dihexylamino)phenyl]ethynyl]-1-(4-sulfobutyl)pyridinium, inner salt (also referred to herein as “Molecule B”); (all-E)-4-[10-[4-(dibutylamino)phenyl]-3,8-dimethyl-1,3,5,7,9-decapentaenyl]-1-(4-sulfobutyl)pyridinium, inner salt (also referred to herein as “Molecule A”); N-(3-triethylammoniumpropyl)-4-(6-(4-(diethylamino)phenyl)hexatrienyl)pyridinium dibromide (also referred to herein as “FM 4-64”); and derivatives thereof.

Suitable staining techniques that can be used in the methods of the present invention include, without limitation, pressure injection of the dye into the cellular tissue, extracellular profusion of the dye over the cellular tissue, addition of dye solids to the cellular tissue, or intracellular application of the dye into the cellular tissue.

The membrane potential signals that are imaged or recorded by the methods of the present invention can have various attributes. For example, the membrane potential signals can spontaneously occur or be stimulated to occur in the cellular tissue. Membrane potential signals that “spontaneously occur” are those membrane potential signals that occur in the cellular tissue without any external stimulation. Membrane potential signals that are “stimulated to occur” include those membrane potential signals that occur as a result of an external stimulus such as, for example, electrical stimulation, neurotransmitter stimulation, neuromodulator stimulation, touch stimulation, sound stimulation, odorant stimulation, and/or visual stimulation.

In one embodiment, when electrical current is used to produce the membrane potential signals, such current can be applied as a pulsed current, modulated current, or constant current. As used herein, the term “pulsed current” includes, but is not limited to, an electrical current of between about 0.1 pico-amps and about 100 micro-amps that is pulsed for a duration of between about 10 microseconds and about 10 minutes, and more particularly an electrical current of between about 100 pico-amps and about 50 micro-amps that is pulsed for a duration of between about 1,000 microseconds and about 10 seconds. As used herein, the term “modulated current” includes pulsed current and means any variation from constant current (see infra for definition of “constant current”). In particular, the term “modulated current” includes, for example, an electrical current of between about 0.1 pico-amps and about 100 micro-amps that is modulated for a duration of between about 10 microseconds and about 10 minutes, and more particularly an electrical current of between about 100 pico-amps and about 100 micro-amps that is modulated for a duration of between about 1,000 microseconds and about 10 seconds. As used herein, the term “constant current” means an electrical current that is applied for a duration of between about 10 microseconds and about 10 minutes at a constant current that is between about 0.1 pico-amps and about 100 micro-amps, and more particularly an electrical current that is applied for a duration of between about 1,000 microseconds and about 10 seconds at a constant current that is between about 100 pico-amps and about 100 micro-amps.

The present invention also relates to a method of detecting and investigating disease within a particular cellular tissue of a living organism. This method involves providing a sample of cellular tissue of a living organism. The sample of cellular tissue is stained with a dye that is sensitive to fast cellular membrane potential signals and capable of generating nonlinear optical signals. Fast cellular membrane potential signals in the sample of cellular tissue are optically recorded by using nonlinear microscopy to produce a high spatiotemporal resolution image of electrical activity in the sample of cellular tissue. The optically recorded fast cellular membrane potential signals in the sample of cellular tissue are compared to those in healthy cellular tissue of the living organism subjected to similar conditions. The method further involves identifying as potentially diseased any sample of cellular tissue that generates different fast cellular membrane potential signals than that of the healthy cellular tissue under similar conditions.

The present invention also relates to a method of detecting membrane potential signal changes in a neuron or in a part of a neuron. This method involves providing a neuron or a part of a neuron. The neuron or part of a neuron is stained with a dye that is sensitive to fast cellular membrane potential signals and capable of generating nonlinear optical signals. The membrane potential signals in the neuron or in the part of the neuron are optically recorded using nonlinear microscopy to produce a high spatiotemporal resolution recording of electrical activity in the neuron or in the part of the neuron. Changes of the membrane potential signals in the neuron or in the part of the neuron are then determined. This method is effective in locating spike initiation zones in the neuron or in the part of the neuron. As used herein, the term “spike initiation zones” means regions on the neuron from where action potentials (e.g., a membrane potential signal propagation) emanate. The number and location of these zones is an important parameter to describe the processing power of a neuron. Knowing the specific location and number of these zones is effective in determining how the brain is “wired” and how neurons communicate with each other to form thoughts and compute information.

The present invention further relates to a method of detecting membrane potential signal changes in a population of cells. This method involves providing a population of cells including at least two cells from a living organism. The population of cells is stained with a dye that is sensitive to fast cellular membrane potential signals and capable of generating nonlinear optical signals. The membrane potential signals in the population of cells are optically recorded using nonlinear microscopy to produce a high spatiotemporal resolution recording of electrical activity in the population of cells. Changes of the membrane potential signals in the population of cells are then determined.

The present invention also relates to a method of detecting membrane potential signal propagation through neurons. This method involves providing at least one neuron. The at least one neuron is stained with a dye that is sensitive to fast cellular membrane potential signals and capable of generating nonlinear optical signals. The at least one neuron is subjected to conditions effective to allow membrane potential signal propagation to occur through the at least one neuron. The membrane potential signals that are generated are optically recorded using nonlinear microscopy to produce a high spatiotemporal resolution image of electrical activity in the neuron. Passage of membrane potential signal propagation through the neuron is then determined.

The methods of the present invention can be used for imaging or recording membrane potential signals in cellular tissue in vivo or in vitro. In particular, the cellular tissue (including a population of cells) used in the methods of the present invention can be contained in the living organism or excised from the living organism for membrane potential imaging or recording.

### EXAMPLES

### Example 1

### Uniform Polarity Microtubule Assemblies Imaged in Native Brain Tissue by Second-Harmonic Generation Microscopy

Microtubule ensemble polarity is a diagnostic determinant of the structure and function of neuronal processes. Polarized microtubule (“MT”) structures are selectively imaged with second-harmonic generation (“SHG”) microscopy in native brain tissue. This SHG is found to colocalize with axons in both brain slices and cultured neurons. Because SHG stems only from non-inversion symmetric structures, the uniform polarity of axonal MTs leads to the observed signal, whereas the mixed polarity in dendrites leads to destructive interference. SHG imaging provides a new tool to investigate the kinetics and function of MT ensemble polarity in dynamic native brain tissue structures and other subcellular motility structures based on polarized MTs.

As demonstrated in Examples 2-13 (infra), the first intrinsic sources of SHG from cultured neurons and acute slices from the hippocampus and other brain regions of rat are described. SHG was observed from axons, but not from dendrites and somata. In acute hippocampal slices, the SHG was found to be prominently localized in the dense unmyelinated axon bundle known as the mossy fibers, with smaller signals from individual axons originating from CA3 pyramidal neurons. Additionally, SHG imaging of native, functioning cilia in the aqueductus cerebri, a brain stem ventricle, is described and SHG time series movies of mitotic spindle development in RBL cells are provided. These signals are shown to arise only from uniform polarity MT ensembles.

### Example 2

### Imaging

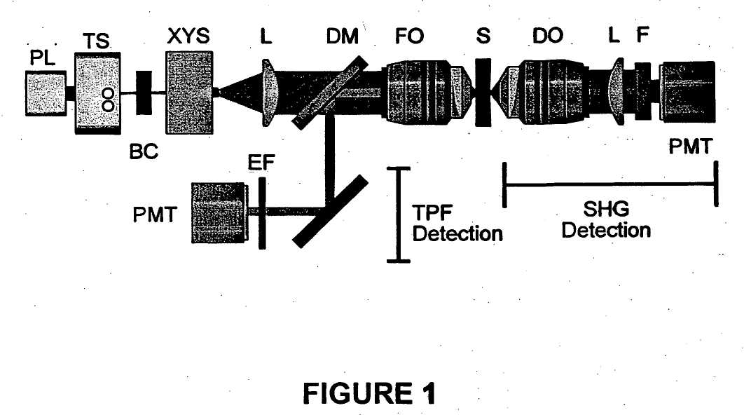

SHG and TPF microscopy were simultaneously performed on either a Bio-Rad MRC 1024 or Radiance scan head on a modified inverted Olympus IX-70 microscope (FIG. 1). The excitation source was a mode-locked Ti:Sapphire laser (˜100 fs pulses at 80 MHz) (Spectra-Physics) pumped by a 5 W solid state Millennia laser (Spectra-Physics). The laser polarization was controlled via a Berek polarization compensator (New Focus, San Jose, Calif.) and the beam focused into the sample with one of the following (overfilled back aperture) objectives: Zeiss C-Apochromat 10×/0.45 NA, Olympus UApo 20×/0.7 NA, Zeiss Fluar 20×/0.75 NA, Olympus UApo 40×/1.15 NA, Zeiss Fluar 40×/1.3 NA. The resultant SHG was collected in the transmitted (forward) direction with an Olympus XLUMPlanFl 20×/0.95 NA objective, while the TPF was epi-collected through the excitation objective. A combination of dichroic mirrors, band-pass and blue-glass filters (Chroma Technology, Brattleboro, Vt.) and polarization analyzers (Newport) separated the signals for detection with Bialkali photo-multiplier tubes (PMTs) (Hammamatsu). The excitation wavelength, average excitation intensity (<I>) at the sample, and two-photon 1/e radial Gaussian beam waist approximation (w) (Richards et al., Proc Royal Soc London Series A-Mathematical Physical Sciences 253:358-379 (1959), which is hereby incorporated by reference in its entirety) are given with the figures. The average power at the sample is (<I>·π·w²). The images are temporally summed over several scans at dwell times ˜10-100 μs/μm². Confocal imaging was performed on the same microscope, but using an argon-krypton laser for excitation.

SHG spectra were recorded by stage scanning the sample and coupling the transmitted light into a liquid N₂ cooled, fiber-coupled spectrometer (Jobin Yvon, Edison, N.J.). Relative effective SHG cross-sections were corrected for power at the sample, transmission of optics, pulse width, etc. Propagation direction distributions were deduced from images of SHG from mossy fibers in both forward and epi propagation directions with fluorescence calibration for absorption and scattering in the tissue and collection efficiency differences of the optics and detectors in each direction.

### Example 3

### Acute Hippocampal Slices

Transverse hippocampal slices 250-400 μm thick were prepared from 14 to 20 day old Sprague-Dawley rat pups using a vibratome, and were incubated at 34° C. in artificial cerebrospinal fluid (ACSF) containing (in mM): 118 NaCl, 3 KCl, 1 KH₂PO₄, 1 MgSO₄, 20 Glucose, 1.5 CaCl₂ and 25 NaHCO₃. The ACSF was oxygenated with 95% O₂ and 5% CO₂. Imaging was performed in ACSF filled glass bottom culture dishes (World Precision Instruments) at room temperature or at 34° C.

### Example 4

### Cell Cultures

Embryonic day 18 rat hippocampi obtained from BrainBits™ (S. Illinois Univ. Sch. Med.) were dissociated and plated in gridded glass cover slip bottom culture dishes (MatTek, Ashland, Mass.) at 5,000-50,000 cells/cm² in phenol red free Neurobasal medium supplemented with B27, 0.5 mM glutamax and 25 μM glutamate (GIBCO). Neurons were incubated at 37° C. in 5% CO₂. Half of the media was replaced every 3-4 days with Neurobasal medium supplemented with B27 and 0.5 mM glutamax. Neurons were imaged in buffer solution containing (in mM): 135 NaCl, 5 KCl, 1 MgCl₂, 1.8 CaCl₂, and 20 Hepes. RBL-2H3 cells were grown in MEM (GIBCO) supplemented with 10% heat inactivated fetal bovine serum and GlutaMAX™ (GIBCO). Stocks were kept in antibiotic free media.

### Example 5

### Immunohistochemistry

Brains from Sprague-Dawley 20-day-old rat pups were perfusion fixed with 4% paraformaldehyde in PBS, post-fixed overnight in the same buffer and embedded in paraffin. Ten μm thick slices were cut and processed for labeling with one of the following primary antibodies: β-tubulin (1:100) (Sigma), MAP2 (1:200) (Chemicon, Temecula, Calif.), Taul (1:200) (Chemicon), SMI 312 (1:200) (Stemberger) or the dynein intermediate chain (1:200) (Abcam, Cambridge, UK). The sections were incubated with secondary antibodies conjugated to the fluorophore cy3 (1:200) (Jackson, West Grove, Pa.).

Cultured neurons were fixed in 3.7% paraformaldehyde in PBS containing 4% sucrose at 37° C. The neurons were processed for labeling with the primary antibodies MAP2 (1:100) (Rabbit, Chemicon) and Taul (1:200) (Mouse, Chemicon) and incubated with rhodamine-conjugated anti-rabbit (50 μg/ml) (Jackson) and coumarin-conjugated anti-mouse (6.25 μg/ml) (Jackson) secondary antibodies.

### Example 6

### Pharmacology

The slices were transferred from the static incubation bath to a static ASCF bath on the microscope stage. The bath was constantly equilibrated with 95% O₂, 5% CO₂ and warmed using an objective heater set to 34° C. Baseline images (6 optical z-sections, 20 μm apart) of SHG from the mossy fibers in all slices were taken every 5 min for 20 min. Subsequently, 4 slices were continuously treated with Nocodazole (Sigma) 25 μM, 4 slices were continuously treated with cytochalasin D (Sigma) 1 μM, and 4 slices (control) received continuous treatment only with solvents (DMSO+0.05% pluronic.) Imaging of the SHG from the same region continued every 5 minutes for 70 minutes. The average intensities from the three groups were calculated and compared for statistical significance with a T-test.

### Example 7

### Physics of SHG

Assuming a uni-axial molecule (as needed here) whose first hyperpolarizability tensor, \overline{β}, is dominated by a single component, β₀, the radiated SHG intensity (I_{2ω}) at twice the illumination frequency is proportional to the square of the illumination intensity (I_{ω}) (Moreaux et al., J Opt Soc America B-Optical Physics 17:1685-1694 (2000), which is hereby incorporated by reference in its entirety):
I_{2ω}∝β₀²I_{ω}². (1)
This SHG stems from the power series expansion of the nonlinear induced electric dipole moment (\vec{p}) of a molecule driven by an excitation optical electric field (\vec{E}_{ω}):

$${p}^{->} = {{p}^{->}}_{0} + \overleftrightarrow{α} \cdot {{E}^{->}}_{ω} + \frac{1}{2} \overleftrightarrow{β} \text{:} {{E}^{->}}_{ω} {{E}^{->}}_{ω} + \frac{1}{6} \overleftrightarrow{γ} \text{:} {{E}^{->}}_{ω} {{E}^{->}}_{ω} {{E}^{->}}_{ω} + … , \qquad ( 2 )$$

where \vec{p}₀ is the static electric dipole moment, \vec{α} is the linear polarizability responsible for linear optics and \overline{β} and \overline{γ} are the nonlinear first and second hyperpolarizability tensors, respectively (Chemla et al., Nonlinear Optical Properties of Organic Molecules and Crystals, Orlando: Academic Press (1987); Bloembergen, N., Nonlinear Optics, Singapore; New Jersey: World Scientific (1996), which are hereby incorporated by reference in their entirety). SHG arises from \overline{β}, TPF and third-harmonic generation arise from \overline{γ} (Chemla et al., Nonlinear Optical Properties of Organic Molecules and Crystals, Orlando: Academic Press (1987); Bloembergen, N., Nonlinear Optics, Singapore; New Jersey: World Scientific (1996), which is hereby incorporated by reference in its entirety). Molecules lacking inversion symmetry with highly inducible dipole moment changes along the asymmetric axes lead to large \overline{β} element values. Excitation electric fields interacting with such molecules induce strong SH dipoles that generate SH electromagnetic radiation. A detectable coherent SH signal is generated when scattering molecules of non-inversion symmetry are spatially ordered, giving an overall asymmetry (lack of an inversion center) to the collective structure, allowing phase matching to take place between the individual scatterers. Because SHG requires coherent summation of the local SH radiation fields, I_{2ω} depends quadratically on the number of SH scattering molecules in the focal volume (Moreaux et al., J Optical Soc America B-Optical Physics 17:1685-1694 (2000), which is hereby incorporated by reference in its entirety).

### Example 8

### SHG in the Hippocampus

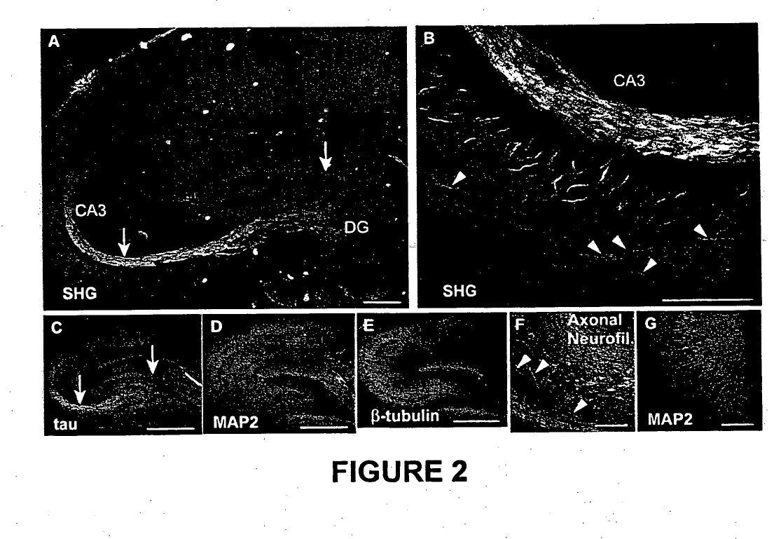

FIG. 2A shows the observed SH signal from a hippocampal slice. The large curved white bundle corresponds to the mossy fiber axons from the dentate gyrus (“DG”) granular neurons that innervate the CA3 pyramidal neurons (Claiborne et al., J Comp Neurol 246:435-458 (1986), which is hereby incorporated by reference in its entirety). FIG. 2B shows a magnified image of processes emanating from the CA3 pyramidal neurons. These processes appear to correspond to the axons leaving the hippocampus to the fimbria and may also give rise to the Schaffer collaterals, which innervate CAI (Finch et al., Brain Res 271:201-216 (1983), which is hereby incorporated by reference in its entirety). A similar morphological correspondence between SHG and axons in other brain regions, i.e., the superior colliculus, cortex and spinal cord, has been found.

Immunological stainings further prove the colocalization of SHG with axons. Tau immunostaining (FIG. 2C) marks axons (Binder et al., J Cell Biol 101:1371-1378 (1985), which is hereby incorporated by reference in its entirety), while MAP2 immunostaining (FIG. 2D) predominantly marks dendrites in slice preparations (Di Stefano et al., J Histochem Cytochem 49:1065-1066 (2001), which is hereby incorporated by reference in its entirety). The tau and SHG signals have almost identical morphological patterns whereas the MAP2 and SHG do not, confirming the axonal and not dendritic origin of the SHG. Note the tau and SHG signals reveal the mossy fibers, but not other axon bundles whose trajectories are out of the plane. β-tubulin immunostaining (FIG. 2E) reveals both axons and dendrites, but as expected, only the axonal portion colocalizes with the SHG. The SHG processes emanating from CA3 pyramidal neurons (FIG. 2B) are similar in morphology to the axonal neurofilament immunostaining of this region (FIG. 2F) (Ulfig et al., Cell Tissue Res 291:433-43 (1998), which is hereby incorporated by reference in its entirety), which reveals these axons better than the tau immunostaining. In contrast, the magnified MAP2 dendritic stain of this region (FIG. 2G) does not reveal these processes. Fixation leads to disappearance of the SHG signal.

### Example 9

### Neuron Culture SHG and Immunohistochemistry

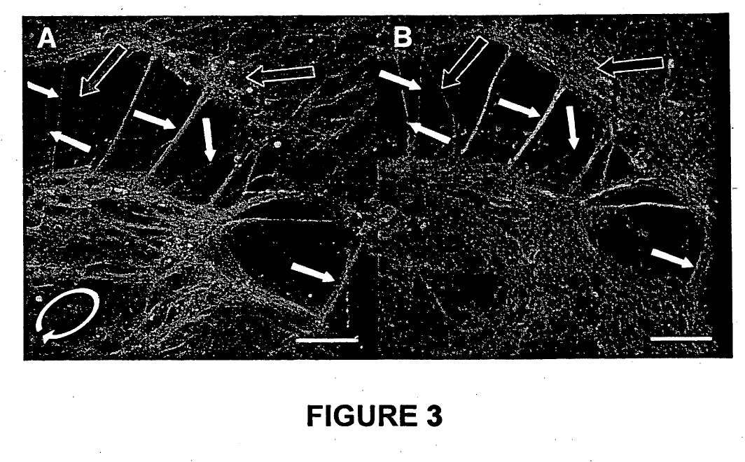

SHG originates from certain processes of hippocampal neurons in cell culture (FIG. 3A). MAP2 immunostaining (marking dendrites and somata in culture) (Mandell et al., Neurobiol Aging 16:229-237 (1995), which is hereby incorporated by reference in its entirety) and tau immunostaining (marking axons) (Mandell et al., Neurobiol Aging 16:229-237 (1995), which is hereby incorporated by reference in its entirety)) (FIG. 3B) performed after SHG and TPF imaging reveal that the SHG and tau signals colocalize, further confirming the axonal origin, while dendrites and somata do not lead to SHG.

### Example 10

### Pharmacology: MTs Source of SHG

Because SHG requires spatially ordered non-inversion symmetric structures, it has been hypothesized that the signal stems from one or more of the polymerized filaments in axons. MTs and actin filaments satisfy this requirement, but inversion symmetric neurofilaments do not (Lee et al., Ann Rev Neuroscience 19:187-217 (1996), which is hereby incorporated by reference in its entirety). To test the dependence of the SHG on MTs and actin filaments, pharmacological agents known to depolymerize them selectively were employed.

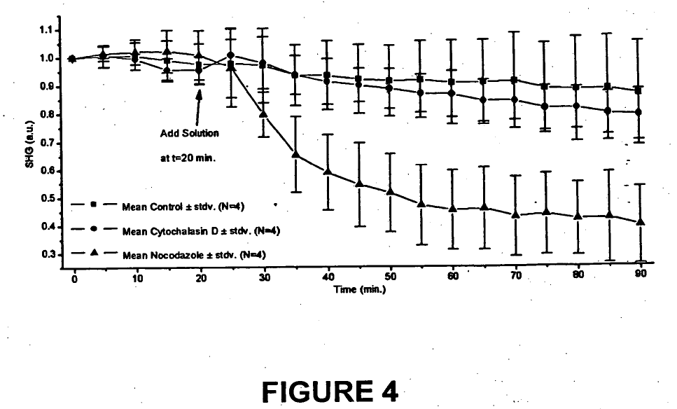

Nocodazole depolymerizes MTs in neuronal cell types (Baas et al., J Cell Biol 116:1231-1241 (1992), which is hereby incorporated by reference in its entirety). FIG. 4 shows the effect of nocodazole on the SHG from the mossy fibers. After the addition of the drug, the SHG decreased to ˜39% of its original value, as expected for this short duration treatment (Baas et al., J Cell Biol 111:495-509 (1990), which is hereby incorporated by reference in its entirety), and the control remained at 87% of its original value. The slight SHG drop during the control experiment can be explained by the spontaneous depolymerization of MTs in the ex vivo environment. The control and nocodazole experiments are significantly different (T-test: p=0.006). Given the specificity of nocodazole to MTs, the decrease in signal shows a direct correlation between MTs and the SHG.

Cytochalasin D depolymerizes the actin cytoskeleton in neuronal cell types (Bradke et al., Science 283:1931-1934 (1999), which is hereby incorporated by reference in its entirety). It is seen in FIG. 4 that this drug had no significant effect on the SHG compared to the control. The two data sets are not significantly different (T-test: p=0.49). Given the specificity of cytochalasin D to actin filaments, this shows that there is no correlation between actin and the SHG.

### Example 11

### SHG from MTs in Non-Neuronal Structures

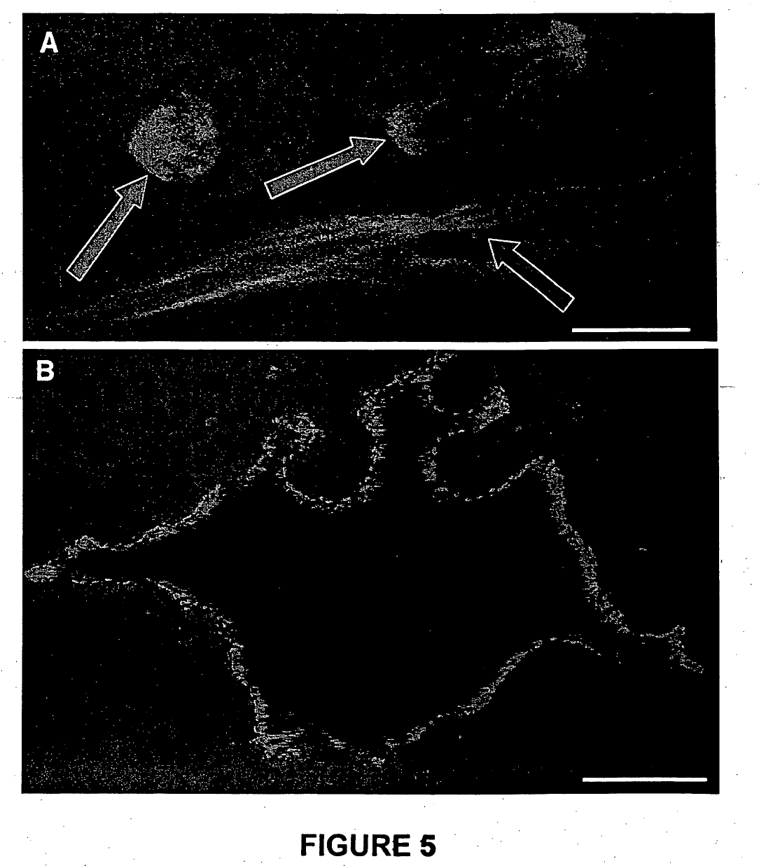

Non-neuronal cell structures with well-organized MT ensembles provide further evidence that SHG arises from MTs. It has previously been shown that mitotic spindles from developing C. elegans embryos generate SH signals under similar experimental conditions to ours (Campagnola et al., Biophys J 82:493-508 (2002), which is hereby incorporated by reference in its entirety). It has been found that distinct SH signals are also generated from the mitotic spindles of M-phase RBL cells and from MTs nucleated from their centrosomes during interphase (FIG. 5A). Additionally, in brain stem slices it has been found that cilia lining the inner walls of the ventricles lead to SHG (FIG. 5B). Further supporting information (i.e., time series movie of cilia motion imaged via SHG) is found in the online version of Dombeck et al., “Uniform Polarity Microtuble Assembles Imaged in Native Brain Tissue by Second-Harmonic Generation Microscopy,” Proc Nat'l Acad Sci USA 100 (12):7081-7086 (2003) (found at www.pnas.org/cgi/reprint/100/12/7081), which is hereby incorporated by reference in its entirety).

### Example 12

### Signal Characterization as SHG

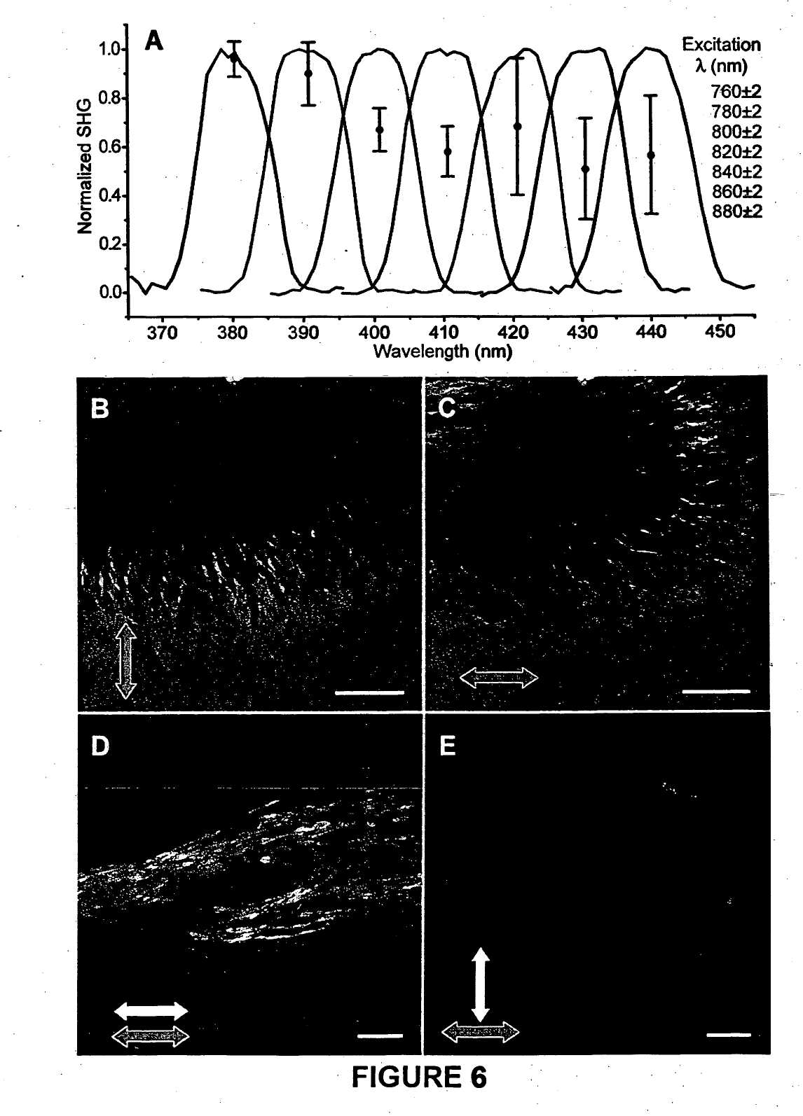

To establish the SH nature of the brain signal, the quadratic (2.01±0.05) dependence of the signal on I_{ω} was first noted. This is consistent with two-photon processes including SHG and TPF. Next, spectra were taken from a 100 μm by 100 μm square region of the mossy fibers with varying excitation wavelengths (FIG. 6A). The emission peaks occur at exactly half of the excitation wavelength. This is consistent with SHG, and it excludes TPF emission which is typically Stokes shifted by many 10's of nm from the SH wavelength and remains constant regardless of substantial variation in excitation wavelength. Additionally, with an excitation bandwidth of 10 nm, the SHG bandwidth should be 10/\sqrt{2} nm, typically 5-10 times less broad than fluorescence emission. The relative effective SHG cross-section increases as the excitation is tuned toward shorter wavelengths (FIG. 6A).

It was found that the SHG propagates mostly in the forward direction. Taking collection efficiencies of objectives (10×, 0.45 NA focusing and 20×, 0.95 NA condensing objectives), filters and detectors into account, the ratio of forward to epi propagating SHG is 9.8±2.9 and 9.6±1.8 with the focusing objective changed to a 40×, 1.15 NA. Such an obvious anisotropic emission is characteristic of SHG, but in stark contrast to the isotropic emission of TPF.

Finally, it was found that the SHG from axons is strongly polarization dependent, maximum with the excitation light polarized parallel to the axons (FIGS. 6B and 6C), and essentially no SHG with the excitation polarized perpendicular to the axons (FIGS. 6B and 6C). A similar effect is found in the SHG emission polarization. SHG is observed with an analyzer in front of the detector oriented parallel to the excitation polarization and excited axons (FIG. 6D). As the analyzer is rotated toward a perpendicular configuration, the detected signal disappears (FIG. 6E).

### Example 13

### Discussion: Uniform Polarity Microtubule Assemblies Imaged in Native Brain Tissue by Second-Harmonic Generation Microscopy

Having established the MT origin of the SHG, the results reported in Examples 8-12 (supra) are understandable. Specifically, it helps to explains why SHG is seen only from axons, although dendrites and, to a lesser extent, somata (Yu et al., J Cell Biol 122:349-359 (1993), which is hereby incorporated by reference in its entirety) also contain MTs. The differences lie in the polarity of the MTs. EM “hook method” studies of the orientation of the MT ensembles in differentiated cultured hippocampal neurons have shown that the MTs in the axons have uniform polarity, they are 95% aligned with their plus ends distal to the soma, giving an overall non-inversion symmetric ensemble structure (Baas et al., Proc. Nat'l Acad. Sci. USA 85:8335-8339 (1988), which is hereby incorporated by reference in its entirety). In contrast, MTs in dendrites have mixed polarity with ˜50% with their +ends distal to the soma and ˜50% oppositely oriented. No concentrations of uniform polarity MTs are found in the dendrites, giving an overall inversion symmetric ensemble structure (Baas et al., Proc Nat'l Acad Sci USA 85:8335-8339 (1988), which is hereby incorporated by reference in its entirety). In fact, the SH generating regions of interphase RBL cells, cilia, mitotic spindles and axons have only one thing in common: uniform polarity MTs (see infra). Therefore, it has been shown that uniform polarity MT ensembles support SHG and are responsible for the SHG seen here in axons.

MT Associated Proteins (“MAPs”) and Molecular Motors not SHG Source. The nocodazole depolymerization, immunostaining and morphology experiments that indicate the MT origin of the SH signal do not rigorously exclude MAPs or molecular motors as possible SH generators. These molecules could, in principle, gain the orientation necessary to support SHG through their binding to the polar MTs, leading to SHG in regions where MTs are aligned with uniform polarity. However, the (tubulin)/(MAP or molecular motor) number ratio is ˜10-100 (Hirokawa et al., J Cell Biol 101:227-239 (1985); Hyams et al., Microtubules New York: Wiley-Liss (1994), which is hereby incorporated by reference in its entirety). Therefore, the quadratic dependence of the SHG on the number of scatterers makes MTs the effective signal generators. Although the MT structures generating SH contain various different MAPs and molecular motors, the only elements common to all of these structures are uniform polarity MTs and dynein (Baas, P. W., Neuron 22:23-31 (1999); Baas et al., Proc Nat'l Acad Sci USA 85:8335-8339 (1988), Hyams et al., Microtubules New York: Wiley-Liss (1994); Sharp et al., Nature 407:41-47 (2000); Euteneuer et al., Proc Nat'l Acad Sci USA 78:372-376 (1981); Bloom et al., J Cell Biol 98:331-340 (1984); Avila, J., Microtubule Proteins, Boca Raton, Fla.: CRC Press (1990); and Huber et al., J Cell Biol 100:496-507 (1985), which are hereby incorporated by reference in their entirety). In mitotic spindles the dynein is quite sparse and is known to be localized in specific regions; therefore it cannot account for the observed pattern of SHG (Sharp et al., Nature 407:41-47 (2000), which is hereby incorporated by reference in its entirety). The immunological stains of hippocampal brain slices for dynein reveal a distribution having no resemblance to the SHG morphology. These facts show that MAPs and molecular motors do not significantly participate in the SHG.

Axons Versus Dendrites in SHG. Individual MTs contain an overall axial asymmetry, however, the elements of the hyperpolarizability tensor, \overline{β}, are not known. Because MTs are aligned with axons and dendrites (Baas et al., Proc Nat'l Acad Sci USA 85:8335-8339 (1988)), the observed excitation polarization effect (FIGS. 6B and 6C) shows that SH dipole radiation is produced when the MTs and the excitation polarization vector are parallel. Excitation polarization perpendicular to MTs yields no SHG. The emission polarization experiments (FIGS. 6D and 6E) show that SH dipoles are induced along the asymmetric axial direction of the MT polymer, proving the existence of a dominant diagonal element of \overline{β}. It has been presumed that the loss of SHG after fixation is due to protein cross-linking disrupting the electronic configuration and increasing the inversion symmetry of the MTs.

To understand physically the difference in SHG between axons and dendrites, the phase of the induced SH electric dipole in each MT must be considered. The relative phase between neighboring MT SH dipoles is determined by the relative polarity of the MTs. If MTs are aligned with the same axial polarity (axons), the induced SH dipoles will be in phase; and if they are aligned with opposite axial polarity (dendrites) the SH dipoles will be 180° out of phase. The MTs in axons and dendrites are typically separated by a sub-resolution distance of 90 nm, corresponding to ⅕ of a wavelength for 440 nm SH light (Baas et al., Proc Nat'l Acad Sci USA 85:8335-8339 (1988), Peters et al., The Fine Structure of the Nervous System:Neurons and Their Supporting Cells, New York: Oxford University Press (1991); Baas et al., J Cell Biol 109:3085-3094 (1989); Yu et al., J Neuroscience 14:2818-2829 (1994), which are hereby incorporated by reference in their entirety). Because of this extreme proximity, the SH dipole radiation produced by neighboring MTs in axons will constructively combine to produce coherent propagating SH radiation whereas the radiation from MTs in dendrites will destructively interfere producing no SH radiation. Although this explanation is qualitatively sufficient, a detailed calculation of the radiated SH signal generated by a focused laser beam is complicated (Mertz et al., Optics Comm 196:325-330 (2001), which is hereby incorporated by reference in its entirety), requiring coherent summation of the SH radiation from each MT driven at the local phase of the focused excitation illumination.

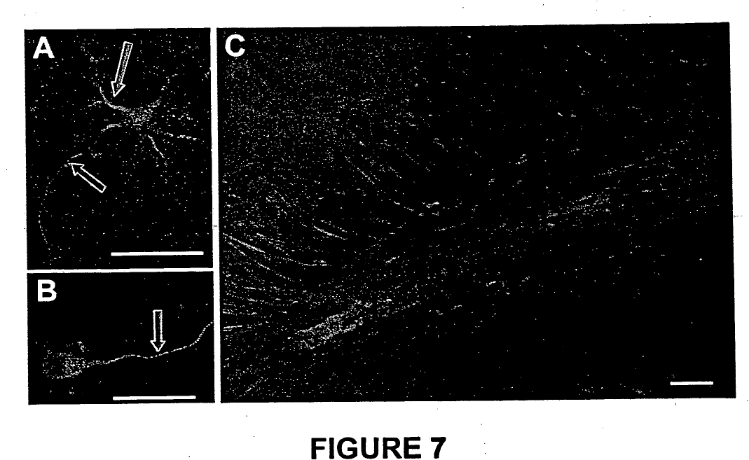

Photodamage Minimization. Because the SHG is relatively weak, it is necessary to use relatively high average laser intensities (<I>) at the sample and temporal summing for an acceptable signal to background ratio (S/B˜2) in imaging. The high <I> used here (˜10-100 MW/cm²) may cause photodamage through absorption, but not through SHG due to its non-absorptive scattering photophysics. Fortunately, the long wavelength excitation (˜880 nm) predominantly used here is relatively benign since its absorption in tissue is negligible. It has been found that with 880 nm excitation with <I>=50.2 MW/cm² (w=0.16 μm, where w is the two-photon radial beam waist) and 118 μs/μm² dwell time, it is possible to watch RBL cells dividing while imaging their mitotic spindles with SHG. For supporting series movie, see the online version of Dombeck et al., “Uniform Polarity Microtuble Assembles Inaged in Native Brain Tissue by Second-Harrnonic Generation Microscopy,” Proc Nat'l Acad Sci USA 100 (12):7081-7086 (2003) (found at www.pnas.org/cgi/reprint/100/12/7081), which is hereby incorporated by reference in its entirety. These cells divide and fully “pinch off,” showing their tolerance of the incident laser intensity and full functioning of the mitotic machinery. This two-photon excitation dose (<I>² times dwell time) is 10 times the dose used during our deep brain tissue imaging experiments (i.e., FIG. 2A). High <I> at 880 nm appears to be acceptable for repeated imaging of MT polarity development in living neuronal samples. The same cell division experiments repeated with 780±20 nm excitation showed no signs of mitotic activity. SHG imaging at ˜780 nm (i.e., FIG. 7) allows ˜10 scans in tissue and neuron cultures before photoinduced morphological changes are seen and SHG begins to disappear. Considering these problems, it may be desirable to take “snapshots” of the MT polarity at shorter wavelengths to increase S/B (FIG. 6A) or to simultaneously image fluorophores with TP cross-sections or fluorescent emissions incompatible with SHG from 880 nm excitation. For repeated imaging of morphological development of MTs in living samples by SHG, the longer wavelengths are clearly preferred.

Applications of SSHG Imaging of MTs. It has been shown (see Examples 1-12 supra) that SHG is well suited for imaging uniform polarity MT ensembles deep in living brain tissue and will find many applications. For example, MTs have been at the heart of many neuronal polarity development studies, involving transport, ensemble polarity, stabilization and density (Baas, P. W., Neuron 22:23-31 (1999); Baas, P. W., Int'l Rev Cytology—A Survey of Cell Biology, 212:41-62 (2002); Rakic et al., Proc Nat'l Acad Sci USA 93:9218-9222 (1996); and Teng et al., J Cell Biol 155:65-76 (2001), which are hereby incorporated by reference in their entirety). Nearly all such studies have been performed in vitro or in fixed samples, but many questions remain about the bearing their results have on neuronal development in vivo (Craig et al., Ann Rev Neuroscience 17:267-310 (1994), which is hereby incorporated by reference in its entirety). FIG. 7 demonstrates the possibility of following such development in unfixed in vitro and ex vivo samples with SHG. Similarly, little is known about MT ensemble polarity in active growth cones, neuronal repair, the dynamics of migrating cells and neurodegenerative diseases. SHG should prove valuable for studies on these and other dynamic MT structures in living tissue, offering new insights into MT ensemble polarity in systems currently beyond previous techniques.

### Example 14

### Optical Recording of Action Potentials with Second-Harmonic Generation Microscopy

Nonlinear microscopy has proven to be essential for neuroscience investigations of thick tissue preparations; however, the optical recording of fast (˜1 ms) cellular electrical activity has never until now been successfully combined with this imaging modality. As demonstrated in Examples 15-21 (infra), through the use of second-harmonic generation microscopy of primary Aplysia neurons in culture labeled with 4-[[4-(dihexylamino)phenyl]]ethynyl]-1-(4-sulfobutyl)pyridinium, inner salt, action potentials with 0.833 ms temporal and 0.6 μm spatial resolution on soma and neurite membranes were optically recorded. Second-harmonic generation response as a function of change in membrane potential was found to be linear with a signal change of ˜6%/100 mV. The signal-to-noise ratio was S/N ˜1 for single trace action potential recordings, but was readily increased to S/N ˜6-7 with temporal averaging of ˜50 scans. Photodamage was determined to be negligible by observing action potential characteristics, cellular resting potential and gross cellular morphology during and after laser illumination. High-resolution optical recording of membrane potential activity has been limited by previous techniques to sample thickness an order of magnitude less than nonlinear methods. Because second-harmonic generation is capable of imaging up to ˜400 μm deep into intact tissue with submicron resolution and little out-of-focus photodamage or bleaching, its ability to record fast electrical activity should prove valuable to future electrophysiology studies.

### Example 15

### Primary Cell Culture

Abdominal and cerebral ganglia from up to 15 different 5-10 g Aplysia californica were dissociated and cultured with like ganglia (i.e., abdominal with abdominal, cerebral with cerebral) according to Banker and Goslin (i.e., Banker et al., Culturing Nerve Cells, 2nd Edition, Cambridge, Mass.: MIT Press (1998), which is hereby incorporated by reference in its entirety). The cultures were grown in MatTek glass bottom dishes (MatTek Corp., Ashland, Mass.) at 17-18 C. For recordings, 4 to 14 day old cultures were used.

### Example 16

### Staining and Imaging

For staining and imaging, 4-[[4-(dihexylamino)phenyl]]ethynyl]-1-(4-sulfobutyl)pyridinium, inner salt (“DHPESBP”) (“Molecule B” from Moreaux et al., “Electro-Optic Response of Second-Harmonic Generation Membrane Potential Sensors,” Optics Letters 28:625-627 (2003), which is hereby incorporated by reference in its entirety) was used, because of its proven fast (<150 μs) response to Vₘ. SHG from giant unilamellar vesicles stained with this molecule was sensitive to Vₘ on fast time scales through an electrochromic (rather than reorientational) mechanism (Moreaux et al., “Electro-Optic Response of Second-Harmonic Generation Membrane Potential Sensors,” Optics Letters 28:625-627 (2003), which is hereby incorporated by reference in its entirety). Here, staining was accomplished by extracellular perfusion of 8 μM dye in SL-15 extra cellular buffer (Banker et al., Culturing Nerve Cells, 2nd Edition, Cambridge, Mass.: MIT Press (1998), which is hereby incorporated by reference in its entirety). The dye remained in the bath during the experiments and the flip-flop time of a similar dye to the inner leaflet of a stained membrane was previously found to be ˜2 hours (Moreaux et al., “Coherent Scattering in Multi-Harmonic Light Microscopy,” Biophys J 80:1568-1574 (2001), which is hereby incorporated by reference in its entirety). The SHG imaging system has been described elsewhere (Dombeck et al., “Uniform Polarity Microtubule Assemblies Imaged in Native Brain Tissue by Second-Harmonic Generation Microscopy,” Proc Nat'l Acad Sci USA 100:7081-7086 (2003), which is hereby incorporated by reference in its entirety), except here the transmitted light condensing objective was replaced by a 0.9 numerical aperture (“NA”) condenser, modified to switch easily between DIC wide-field imaging and SHG collection. The focusing objective was also changed to a 20×, 0.75 NA Zeiss Fluar, making a diffraction limited ˜0.6 μm radial diameter focal spot. The Ti:Sapphire laser was operated at 940 nm with ˜12 mW of average power at the sample, and a 460/30 band pass filter was used for SHG detection in front of the bi-alkali photomultiplier tube. The excitation polarization was linear.

### Example 17

### Optical and Electrode Voltage Recording

Electrophysiological recordings of Aplysia neuron cultures were made at room temperature with an Axoclamp 2B amplifier and pClamp 8.1 software. Two-electrode voltage clamp was used to clamp Vₘ at defined values. For stimulation of APs the neuron was impaled with two microelectrodes (8-15 MΩ, filled with 3 M KCl), one for voltage recording and the other for current injection. AP stimulation was possible with <5 nA, ˜50 ms duration current pulses as used previously (Bedi et al., “Long-Term Effects of Axotomy on Excitability and Growth of Isolated Aplysia Sensory Neurons in Cell Culture: Potential Role of Camp,” J Neurophysiol 79:1371-1383 (1998); Rubakhin et al., “Characterization of the Aplysia Californica Cerebral Ganglion F Cluster,” J Neurophysiol 81:1251-1260 (1999), which are hereby incorporated by reference in their entirety), however shorter more intense pulses (30-100 nA, 1.0-3.5 ms duration) were used here to quickly reach threshold. This shorter stimulation protocol afforded an AP temporal stability of <0.5 ms peak voltage drift over the minutes of signal averaging that was not possible with the longer protocol (>3 ms drift), obviating the need for post processing. The necessary temporal resolution to optically detect APs with SHG was obtained using the line scanning mode of the scanning system (600 to 1200 lines/sec). X-Y images were taken by raster scanning the focal spot over the two-dimensional field of view, while one line was repeatedly scanned 256 times during line scanning. Each 8-bit image is built of 256 pixels in each dimension. The line scanning and stimulation or voltage clamping steps were synchronized through trigger pulses coupling the amplifier and image acquisition software. Exact timing of the amplifier signals and line scanning was accomplished by recording the Monitor output of the amplifier in one of the line scan imaging channels. This enabled an increase in the S/N through line scan averaging. Each recording session consisted of a number (N) of stimulation/line scans in series with pauses, 4 sec for two-electrode voltage clamp and 3 sec for AP stimulation experiments, to save the images and electrode recordings and reset the system for the next line scan. A typical N=50 session totaled 2-3 minutes in duration.

### Example 18

### Dye Synthesis

The electroNLOchromic dye DHPESBP was obtained via a multi-step synthesis scheme involving a Sonogashira key coupling reaction followed by alkylation with 1,4 butane sultone. An example of the dye synthesis is shown in Scheme 1 (below).

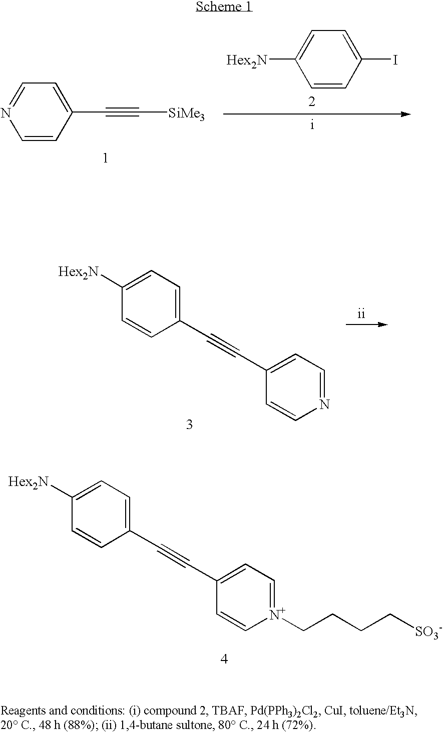

As described in Scheme 1 (step “i”), compound 3 (i.e., N,N-Dihexyl-4-(4-pyridinylethynyl)benzenamine) was synthesized as follows: Air was removed from a solution of compound 1 (i.e., 4-(trimethylsilylethynyl)pyridine) (0.250 g, 1.43 mmol) (Suffert et al., Tetrahedron Lett. 32:757-760 (1991), which is hereby incorporated by reference in its entirety) and compound 2 (i.e., 4-iodo-(N,N-dihexyl)aniline) (0.536 g, 1.38 mmol) (Kapplinger et al., Synthesis 1843-1850 (2002), which is hereby incorporated by reference in its entirety) in 3 mL of toluene/triethylamine (5/1) by blowing argon for 15 min. Then copper iodide (CuI, 5.4 mg, 0.028 mmol), dichlorobis(triphenylphosphine)palladium (Pd(PPh₃)₂Cl₂, 20 mg, 0.028 mmol) and tetrabutylammonium fluoride (TBAF, 1 M solution in THF, 1.43 mL, 1.43 mmol) were added, and deaeration was continued for 10 min. Thereafter the mixture was stirred at 20° C. for 48 h under argon. The solvents were removed under reduced pressure, and the residue was purified by column chromatography (silica gel, CH₂Cl₂/AcOEt, gradient from 100:0 to 90:10) to yield 0.443 g (88%) of compound 3; ¹H NMR (CDCl₃, 200.13 MHz) δ 0.91 (t, J=6.5 Hz, 6H), 1.32 (m, 12H), 1.58 (m, 4H), 3.28 (t, J=7.6 Hz, 4H), 6.57 (d, J=9.0 Hz, 2H), 7.35 (d, J=6.1 Hz, 2H), 7.38 (d, J=9.0 Hz, 2H), 8.57 (d, J=6.1 Hz, 2H); ³C NMR (CDCl₃, 50.32 MHz) δ 13.9, 22.5, 26.6, 26.9, 31.5, 50.7, 84.9, 96.4, 107.0, 110.9, 125.9, 132.3, 133.2, 148.3, 149.3.

As described in Scheme 1 (step “ii”), compound 4 (i.e., 14-[[4-(Dihexylamino)phenyl]ethynyl]-1-(4-sulfobutyl)pyridinium (inner salt) (“DHPESBP”)) was synthesized as follows: A solution of compound 3 (136.9 mg, 0.378 mmol) in 1,4-butanesultone (1.16 mL, 11.33 mmol) was stirred at 80° C. for 24 h. The 1,4-butanesultone in excess was distilled under reduce pressure and the crude product was purified by column chromatography (silica gel, AcOEt then CH₂Cl₂/MeOH 90:10), to afford 135 mg (72%) of compound 4 (i.e., DHPESBP); mp 230° C. (dec.); ¹H NMR (CDCl₃, 200.13 MHz) δ 0.90 (m, 6H), 1.32 (m, 12H), 1.58 (m, 4H), 1.98 (m, 2H), 2.19 (m, 2H), 2.97 (m, 2H), 3.27 (m, 4H), 4.81 (m, 2H), 6.57 (d, J=8.7 Hz, 2H), 7.41 (d, J=8.7 Hz, 2H), 7.73 (d, J=6.5 Hz, 2H), 9.07 (d, J=6.5 Hz, 2H); ³C NMR (CDCl₃, 300.13 MHz) δ 14.0, 22.0, 22.6, 26.7, 27.1, 30.7, 31.6, 50.6, 51.0, 60.4, 86.5, 105.0, 109.9, 111.2, 127.9, 134.9, 140.9, 144.2, 149.9; HRMS (LSIMS+, mNBA) calculated for C₂₉H₄₃N₂O₃S ([M+H]⁺) m/z 499.2994, found 499.2992.

### Example 19

### Spatiotemporal AP recordings with SHG Microscopy

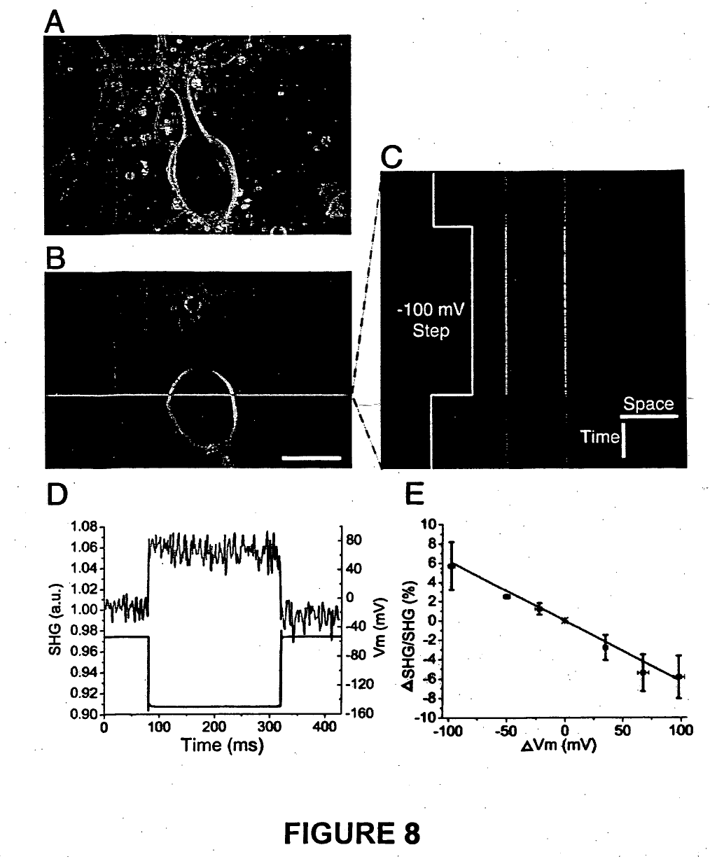

FIGS. 8A and 8B show SHG images of a cultured Aplysia neuron stained with DHPESBP. Because of the noninversion symmetry requirement of SHG, signal is only produced at the labeled membranes; no background from randomly oriented dye is seen. During line scanning of the green line in FIG. 8B, voltage steps were applied to the cell in voltage clamp. S/N was 1 for single traces, necessitating temporal averaging. This was accomplished by synchronizing the start of the line scan with the amplifier voltage steps. After repeated line scan averaging (N=50), the modulations in the SHG emission followed the voltage steps accurately with S/N˜7. This line scan average is scaled to the dynamic range of the SHG response in order to visualize the small change in emission (FIG. 8C). Negative voltage steps resulted in increased SHG emission, while positive voltage steps resulted in decreased emission (FIG. 8D). A linear response of the SHG with respect to ΔVₘ (linear best fit:

$$\frac{Δ SHG}{SHG} = - 0.06 Δ {V}_{m} ,$$

slope error=0.004) was observed by applying a range of voltage steps (FIG. 8E).

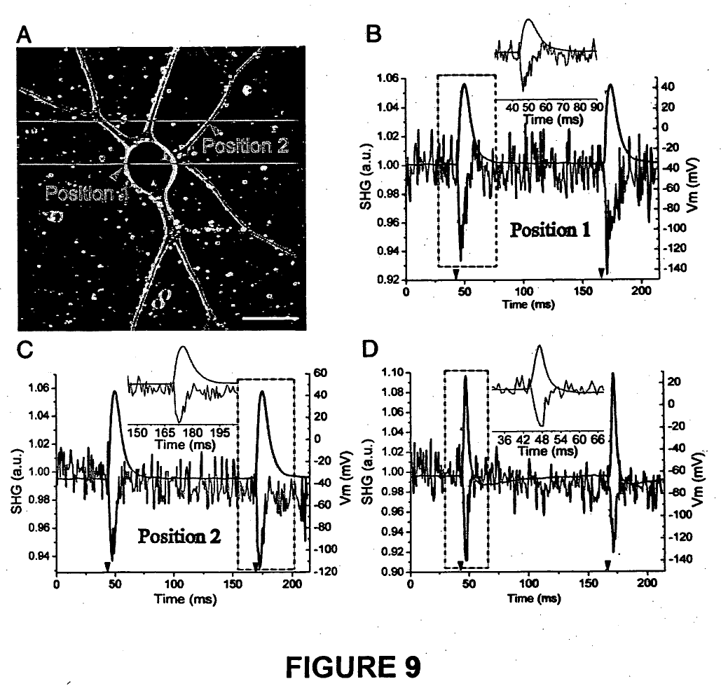

In order to prove the ability of SHG to record fast neuronal signals, APs were elicited and optically recorded. Line scanning positions of two different recording sessions on an Aplysia neuron are represented by the green lines in FIG. 9A, one through the soma and the other through several neurites. During each line scan, two ˜10-15 ms duration APs, consistent with mixed Ca²⁺/Na⁺ APs (Gardner et al., “A Comparison of the Effects of Sodium and Lithium Ions on Action Potentials from Helix aspersa Neurones,” Comp Biochem Physiol 25:33-48 (1968), which is hereby incorporated by reference in its entirety), were elicited through intracellular electrodes (red traces in FIGS. 9B and 9C). Line scan averaging (N=50) showed that the optical intensity modulations in the SHG emission follow the fast Vₘ events with 0.6 μm spatial and 0.833 ms temporal resolution and S/N ˜6 (green traces in FIGS. 9B and 9C). Note that the somatic recording electrode and SHG optical recording positions are different; so the AP shape and duration differ in some instances, as seen previously (Zecevic, D., “Multiple Spike-Initiation Zones in Single Neurons Revealed by Voltage-Sensitive Dyes,” Nature 381:322-325 (1996), which is hereby incorporated by reference in its entirety). The temporal response of SHG is easily capable of recording faster events such as the ˜4 ms duration APs, consistent with Na⁺ APs (Gardner et al., “A Comparison of the Effects of Sodium and Lithium Ions on Action Potentials from Helix Aspersa Neurones,” Comp Biochem Physiol 25:33-48 (1968), which is hereby incorporated by reference in its entirety), seen in FIG. 9D. After line scan averaging (N=70), S/N was ˜7 for this recording session.

The S/N in SHG recording can be understood by analyzing the noise in the baseline of the optical traces. For example, noise of ˜1% is seen in the baseline of FIGS. 9B and 9C. Assuming a shot noise limited system, this equates to a total of ˜10,000 photons collected per membrane during the 50 traces, yielding ˜200 photons during the laser dwell time across the membrane. Therefore, the noise is ˜7% and S/N is ˜1 for N=1.

### Example 20

### Minimal Phototoxicity During Recordings

Little cellular photodamage was detected during the recording sessions with average power of 12 mW, as in those examples presented herein. To evaluate this, it was first noted that the variation in resting potential was <4 mV during individual sessions, equivalent to non-illumination controls. Second, the elicited APs remained constant in amplitude and duration throughout recording sessions compared to non-illumination controls. Finally, no gross morphological changes were detectable in the soma or processes after individual sessions. Repeated optical recording from single neurons was possible over the course of 0.5 hrs. When the power was increased to ˜22 mW, damage was observable. Recording from soma was still possible with little damage, but recording from distal neurites resulted in blebbing and/or transection of the processes at the sites of line scanning. More studies are needed to investigate long-term damage effects and to determine the cause of the phototoxicity and possible avoidance procedures. Although little loss of SHG signal was observed at ˜12 mW, it was more apparent at ˜22 mW.

### Example 21

### Discussion: Optical Recording of Action Potentials with Second-Harmonic Generation Microscopy

An eventual goal of optical Vₘ recording is to image sub-threshold events, without averaging, deep in intact neural tissue with <1 μm and ˜1 ms spatiotemporal resolution. To reach this goal, the SHG S/N for Vₘ recording and imaging frame rate must be improved (i.e., full two dimensional images must be obtained at the same temporal resolution demonstrated here for line scanning). Commonly used commercial scanning systems have a frame rate for full images of ˜1 Hz, thus to obtain the necessary 1 kHz imaging frame rate, new scanning technologies must be implemented. Resonant galvanometer (Gardner et al., “A Comparison of the Effects of Sodium and Lithium Ions on Action Potentials from Helix Aspersa Neurones,” Comp Biochem Physiol 25:33-48 (1968), which is hereby incorporated by reference in its entirety) and microlens (Kobayashi et al., “Second-Harmonic-Generation Microscope with a Microlens Array Scanner,” Optics Letters 27:1324-1326 (2002), which is hereby incorporated by reference in its entirety) based scanners have been used for this purpose, but current demonstrations of these devices only achieve a frame rate of ˜33 Hz. Newer versions of this technology may show promise for faster scan rates (So, PTC, “Modern Applications of 3-D Optical Microscopy in Biology and Medicine,” Conference on Lasers and Electro-Optics-Quantum Electronics and Laser Science Conference, Baltimore, Md. (June 2003), which is hereby incorporated by reference in its entirety). Another possibility is the use of random access scanning (Bullen et al., “High-Speed, Random-Access Fluorescence Microscopy: I. High-Resolution Optical Recording with Voltage-Sensitive Dyes and Ion Indicators,” Biophys J 73:477-491 (1997); and Bullen et al., “High-Speed, Random-Access Fluorescence Microscopy: II. Fast Quantitative Measurements with Voltage-Sensitive Dyes,” Biophys J 76:2272-2287 (1999), which are hereby incorporated by reference in their entirety) to scan over only the membrane region of interest.

Improvements in S/N can come from: (1) Increased laser power; (2) higher dye concentrations in the membrane; (3) higher quantum yield detectors; or (4) better SHG molecules with increases in both hyperpolarizibility and response to Vₘ. The number of emitted photons is proportional to the square of both the dye concentration and the fundamental laser intensity (Moreaux et al., “Membrane Imaging by Second-Harmonic Generation Microscopy,” J Optical Soc America B-Optical Physics 17:1685-1694 (2000), which is hereby incorporated by reference in its entirety). Therefore, increases in either should lead to large decreases in the photon shot noise; methods for decreasing photodamage must be concurrently investigated. Rapid progress is being made on Option 3. New GaAsP photomultiplier tubes, for example, have greater quantum efficiency than the BiAlkali model used here. Option 4 will involve the design and screening of many dyes. It is likely that molecules with greater Vₘ response and increased hyperpolarizibility will be found.

In order to achieve the goal of Vₘ imaging with SHG under the guidelines above, many possible variables may be altered. For example, a ˜20% ASHG/100 mV dye with twice the hyperpolarizibility as DHPESBP, stained and illuminated at twice the concentration and incident power as used here, should be capable of recording a 10 mV subthreshold event with N=1 and S/N>1.

Recording Vₘ activity deep in tissue may be possible in the near future, but sample thickness, staining procedures and tissue type must first be carefully evaluated. Intrinsic SHG imaging at depths up to 300-400 μm with submicron resolution has previously been demonstrated in hippocampal brain slices (Dombeck et al., “Uniform Polarity Microtubule Assemblies Imaged in Native Brain Tissue by Second-Harmonic Generation Microscopy,” Proc Nat'l Acad Sci USA 100:7081-7086 (2003), which is hereby incorporated by reference in its entirety). Because SHG is collected in the transmitted light direction, sample thickness is limited to <˜500 μm. Staining thick turbid media, such as intact ganglia or mammalian neural tissue, has been accomplished by bath applying dye (Delaney et al., “Waves and Stimulus-Modulated Dynamics in an Oscillating Olfactory Network,” Proc Nat'l Acad Sci USA 91:669-673 (1994), which is hereby incorporated by reference in its entirety), but other techniques such as pressure injection of dye (Stosiek et al., “In Vivo Two-Photon Calcium Imaging of Neuronal Networks,” Proc Nat'l Acad Sci USA 100:7319-7324 (2003), which is hereby incorporated by reference in its entirety), intracellular labeling (Antic et al., “Fast Optical Recordings of Membrane Potential Changes from Dendrites of Pyramidal Neurons,” J Neurophysiol 82:1615-1621 (1999), which is hereby incorporated by reference in its entirety), novel GFP constructs (Knopfel et al., “Optical Recordings of Membrane Potential Using Genetically Targeted Voltage-Sensitive Fluorescent Proteins,” Methods 30:4248 (2003), which is hereby incorporated by reference in its entirety), or the addition of dye crystals into tissue (Gan et al., “Multicolor “DiOlistic” Labeling of the Nervous System Using Lipophilic Dye Combinations,” Neuron 27:219-225 (2000); and Moreaux et al., “Coherent Scattering in Multi-Harmonic Light Microscopy,” Biophys J 80:1568-1574 (2001), which are hereby incorporated by reference in their entirety) have previously been needed to stain at these depths. Additionally, varying preparations have previously lead to different sensitivities of the same Vₘ dyes (Zochowski et al., “Imaging Membrane Potential with Voltage-Sensitive Dyes,” Biol Bull 198:1-21 (2000), which is hereby incorporated by reference in its entirety), but a greater issue for SHG dyes may be their effects on more delicate mammalian cells.

With these issues in mind, numerous applications should be possible with SHG Vₘ recording. The current capabilities demonstrated herein are most immediately applicable to reproducibly stimulated systems, as are often used for current optical Vₘ recording techniques (Zecevic, D., “Multiple Spike-Initiation Zones in Single Neurons Revealed by Voltage-Sensitive Dyes,” Nature 381:322-325 (1996), which is hereby incorporated by reference in its entirety). It should be feasible to investigate spike initiation zones (Zecevic, D., “Multiple Spike-Initiation Zones in Single Neurons Revealed by Voltage-Sensitive Dyes,” Nature 381:322-325 (1996), which is hereby incorporated by reference in its entirety) and AP propagation properties (Fromherz et al., “Cable Properties of a Straight Neurite of a Leech Neuron Probed by a Voltage-Sensitive Dye,” Proc Nat'l Acad Sci USA 91:4604-4608 (1994); and Meyer et al., “Cable Properties of Dendrites in Hippocampal Neurons of the Rat Mapped by a Voltage-Sensitive Dye,” Eur JNeurosci 9:778-785 (1997), which are hereby incorporated by reference in their entirety) deep in intact ganglia where one-photon methods are not appropriate. Repeated line scans at varying spatial positions over processes will allow for the generation of high-resolution time series movies of AP propagation, leading to the experimental analysis of electrical propagation properties at complex structures, such as axon bifurcations and varicosities. In addition, SHG Vₘ recording simultaneously with powerful Ca²⁺ imaging techniques (Szmacinski et al., “Calcium-Dependent Fluorescence Lifetimes of Indo-1 for One- and Two-Photon excitation of Fluorescence,” Photochem Photobiol 58:341-345 (1993); and Yuste et al., “Dendritic Spines as Basic Functional Units of Neuronal Integration,” Nature 375:682-684 (1995), which are hereby incorporated by reference in their entirety) should prove to be a useful combination.

Any increase in spatial resolution is valuable for the investigation of Vₘ properties of small structures (i.e., dendritic spines) or for providing higher resolution data of AP propagation. The spatial resolution of ˜0.6 μm demonstrated herein represents the highest resolution optical recording of fast Vₘ activity to date. The potential usefulness of this resolution for AP propagation studies where shape and duration vary depending on position is seen in FIG. 9C, where these differences are clear. Theoretically, similar spatial resolution is possible for the fast one-photon techniques while maintaining the same S/N; however, a higher illumination intensity would be needed, likely resulting in greater photodamage. The highest demonstrated resolution of ˜2 μm was demonstrated by one-photon random access scanning, but like other linear methods, was limited to thin specimens (Bullen et al., “High-Speed, Random-Access Fluorescence Microscopy: I. High-Resolution Optical Recording with Voltage-Sensitive Dyes and Ion Indicators,” Biophys J 73:477-491 (1997); and Bullen et al., “High-Speed, Random-Access Fluorescence Microscopy: II. Fast Quantitative Measurements with Voltage-Sensitive Dyes,” Biophys J 76:2272-2287 (1999), which are hereby incorporated by reference in their entirety).

As demonstrated in Examples 14-20 (supra), SHG microscopy is capable of recording APs from excitable neurons with 0.833 ms temporal resolution at the highest spatial resolution yet reported for fast optical Vₘ recordings. This technique for optically recording Vₘ holds important advantages over current techniques: submicron resolution at depths up to ˜400 μm in scattering tissue, little out-of-focus photodamage or bleaching, and no background. The above work represents a key step toward ˜1 ms time-scale, high-resolution Vₘ imaging deep in intact neural tissue. It is expected that rapid progress will continue to be made toward this goal in the near future.

### Example 22

### Fast Optical Recording of Neuronal Membrane Potential Transients in Acute Mammalian Brain Slices by Second-Harmonic Generation Microscopy

SHG microscopy is emerging as a powerful new method to optically record membrane potential changes of active neurons. This technique has been demonstrated in culture dish preparations, but has yet (until now) been applied to intact neural systems. This technique has been applied to acute rat brain slices by patch clamping and filling neurons in the hippocampal region with the dye FM4-64. When illuminated with ˜1060 nm/˜300 fs laser pulses, the labeled inner membrane leaflet shows an intense forward propagating SHG signal from the of the soma and processes hundreds of microns deep. The SHG signal emanates from the plasma membrane with little background from intra- or extracellular regions. Due to the molecular alignment requirement of SHG, this technique has the advantage over two-photon fluorescence in that the effective response to membrane potential is not significantly attenuated by background. Additionally, it has been shown that a backward propagating SHG signal exists (Forward/Backward ratio ˜6).

Repeated line scanning of the SHG signal was used to optically record action potentials (signal to noise ratio (S/N) ˜5-8 by temporal averaging of ˜50 line scans) on somatic membranes. Voltage steps were applied at the soma and the SHG response was recorded in the dendritic arbor >100 μm deep in slice. Dendritic spines were clearly visible, possibly making the recording of membrane potential transients from these compartments feasible. The SHG signal shows a linear response of ˜7.7%/100 mV. The line scan averaging necessary to increase S/N was accomplished in minutes. Micron spatial and 0.83 ms temporal resolution was demonstrated. In addition to patch clamping, it was shown that extracellular micropipette pressure injection of the dye into hippocampal cell layers leads to SHG labeling of many tens of neurons.

Although preferred embodiments have been depicted and described in detail herein, it will be apparent to those skilled in the relevant art that vanous modifications, additions, substitutions, and the like can be made without departing from the spirit of the invention and these are therefore considered to be within the scope of the invention as defined in the claims which follow.

1. A method of producing a high spatiotemporal resolution image of electrical activity in cellular tissue, said method comprising:
staining the cellular tissue with a dye that is sensitive to fast cellular membrane potential signals and capable of generating nonlinear optical signals; and
optically imaging fast cellular membrane potential signals in the cellular tissue by using nonlinear microscopy to produce a high spatiotemporal resolution image of electrical activity in the cellular tissue.

2. The method according to claim 1, wherein said fast cellular membrane potential signals comprise action potentials, sub-threshold events, or a combination of action potentials and sub-threshold events.

3. The method according to claim 1, wherein said nonlinear microscopy comprises second-harmonic generation microscopy, third-harmonic generation microscopy, fourth-harmonic generation microscopy, or fifth-harmonic generation microscopy.

4. The method according to claim 1, wherein said nonlinear microscopy comprises multiphoton excitation.

5. The method according to claim 1, wherein said nonlinear microscopy comprises multiphoton excitation and second-harmonic generation microscopy.

6. The method according to claim 1, wherein the dye is a styryl dye.

7. The method according to claim 6, wherein said styryl dye is selected from the group consisting of 4-[[4-(dihexylamino)phenyl]ethynyl]-1-(4-sulfobutyl)pyridinium, inner salt; (all-E)-4-[10-[4-(dibutylamino)phenyl]-3,8-dimethyl-1,3,5,7,9-decapentaenyl]-1-(4-sulfobutyl)pyridinium, inner salt; N-(3-triethylammoniumpropyl)-4-(6-(4-(diethylamino)phenyl)hexatrienyl)pyridinium dibromide; and derivatives thereof.

8. The method according to claim 1, wherein the membrane potential signals spontaneously occur or are stimulated to occur in the cellular tissue.

9. The method according to claim 1, wherein the membrane potential signals are produced by applying neurotransmitters or neuromodulators to the cellular tissue.

10. The method according to claim 1, wherein the membrane potential signals are produced by applying an electrical current to the cellular tissue.

11. The method according to claim 10, wherein the electrical current is applied as a pulsed current.

12. The method according to claim 10, wherein the electrical current is applied as a modulated current.

13. The method according to claim 10, wherein the electrical current is applied as a constant current.

14. The method according to claim 1, wherein said cellular tissue is from a living organism.

15. The method according to claim 1, wherein said high spatiotemporal resolution image of electrical activity is produced in the cellular tissue in vitro or in vivo.

16. The method according to claim 1, wherein said cellular tissue is capable of generating electrical activity.

17. The method according to claim 1, wherein said cellular tissue is a membrane.

18. The method according to claim 1, wherein said cellular tissue comprises a neuron or a part of a neuron.

19. The method according to claim 18, wherein said part of a neuron is selected from the group consisting of an axon, a dendrite, a fine dendrite, a dendritic spine, a soma, and subparts thereof.

20. The method according to claim 1, wherein said cellular tissue comprises microtubules.

21. The method according to claim 1, wherein said staining comprises pressure injection of the dye into the cellular tissue, extracellular profusion of the dye over the cellular tissue, addition of dye solids to the cellular tissue, or intracellular application of the dye into the cellular tissue.

22. A method of detecting and investigating disease within a particular cellular tissue of a living organism, said method comprising:
providing a sample of cellular tissue of a living organism;
staining the sample of cellular tissue with a dye that is sensitive to fast cellular membrane potential signals and capable of generating nonlinear optical signals;
optically recording fast cellular membrane potential signals in the sample of cellular tissue by using nonlinear microscopy to produce a high spatiotemporal resolution image of electrical activity in the sample of cellular tissue;
comparing the optically recorded fast cellular membrane potential signals in the sample of cellular tissue to that in healthy cellular tissue of the living organism subjected to similar conditions; and
identifying as potentially diseased any sample of cellular tissue that generates different fast cellular membrane potential signals than that of the healthy cellular tissue under similar conditions.

23. The method according to claim 22, wherein said fast cellular membrane potential signals comprise action potentials, sub-threshold events, or a combination of action potentials and sub-threshold events.

24. The method according to claim 22, wherein said nonlinear microscopy comprises second-harmonic generation microscopy, third-harmonic generation microscopy, fourth-harmonic generation microscopy, or fifth-harmonic generation microscopy.

25. The method according to claim 22, wherein said nonlinear microscopy comprises multiphoton excitation.

26. The method according to claim 22, wherein said nonlinear microscopy comprises multiphoton excitation and second-harmonic generation microscopy.

27. The method according to claim 22, wherein the dye is a styryl dye.

28. The method according to claim 27, wherein said styryl dye is selected from the group consisting of 4-[[4-(dihexylamino)phenyl]ethynyl]-1-(4-sulfobutyl)pyridinium, inner salt; (all-E)-4-[10-[4-(dibutylamino)phenyl]-3,8-dimethyl-1,3,5,7,9-decapentaenyl]-1-(4-sulfobutyl)pyridinium, inner salt; N-(3-triethylammoniumpropyl)-4-(6-(4-(diethylamino)phenyl)hexatrienyl)pyridinium dibromide; and derivatives thereof.

29. The method according to claim 22, wherein the membrane potential signals spontaneously occur or are stimulated to occur in the cellular tissue.

30. The method according to claim 22, wherein the membrane potential signals are produced by applying neurotransmitters or neuromodulators to the cellular tissue.

31. The method according to claim 22, wherein the membrane potential signals are produced by applying an electrical current to the cellular tissue.

32. The method according to claim 31, wherein the electrical current is applied as a pulsed current.

33. The method according to claim 31, wherein the electrical current is applied as a modulated current.

34. The method according to claim 31, wherein the electrical current is applied as a constant current.

35. The method according to claim 22, wherein the optically recorded fast cellular membrane potential signals in the sample of cellular tissue and in the healthy cellular tissue are compared in vitro or in vivo.

36. The method according to claim 22, wherein said cellular tissue is capable of generating electrical activity.

37. The method according to claim 22, wherein said cellular tissue is a membrane.

38. The method according to claim 22, wherein said cellular tissue comprises a neuron or a part of a neuron.

39. The method according to claim 38, wherein said part of a neuron is selected from the group consisting of an axon, a dendrite, a fine dendrite, a dendritic spine, a soma, and subparts thereof.

40. The method according to claim 22, wherein said cellular tissue comprises microtubules.

41. The method according to claim 22, wherein said staining comprises pressure injection of the dye into the cellular tissue, extracellular profusion of the dye over the cellular tissue, addition of dye solids to the cellular tissue, or intracellular application of the dye into the cellular tissue.

42. A method of detecting membrane potential signal changes in a neuron or in a part of a neuron, said method comprising:
providing a neuron or a part of a neuron;
staining the neuron or the part of the neuron with a dye that is sensitive to fast cellular membrane potential signals and capable of generating nonlinear optical signals;
optically recording membrane potential signals in the neuron or in the part of the neuron using nonlinear microscopy to produce a high spatiotemporal resolution recording of electrical activity in the neuron or in the part of the neuron; and
determining changes of membrane potential signals in the neuron or in the part of the neuron.

43. The method according to claim 42, wherein said fast cellular membrane potential signals comprise action potentials, sub-threshold events, or a combination of action potentials and sub-threshold events.

44. The method according to claim 42, wherein said nonlinear microscopy comprises second-harmonic generation microscopy, third-harmonic generation microscopy, fourth-harmonic generation microscopy, or fifth-harmonic generation microscopy.

45. The method according to claim 42, wherein said nonlinear microscopy comprises multiphoton excitation.

46. The method according to claim 42, wherein said nonlinear microscopy comprises multiphoton excitation and second-harmonic generation microscopy.

47. The method according to claim 42, wherein the dye is a styryl dye.

48. The method according to claim 47, wherein said styryl dye is selected from the group consisting of 4-[[4-(dihexylamino)phenyl]ethynyl]-1-(4-sulfobutyl)pyridinium, inner salt; (all-E)-4-[10-[4-(dibutylamino)phenyl]-3,8-dimethyl-1,3,5,7,9-decapentaenyl]-1-(4-sulfobutyl)pyridinium, inner salt; N-(3-triethylammoniumpropyl)-4-(6-(4-(diethylamino)phenyl)hexatrienyl)pyridinium dibromide; and derivatives thereof.

49. The method according to claim 42, wherein said membrane potential signals spontaneously occur or are stimulated to occur in the neuron or in the part of the neuron.

50. The method according to claim 42, wherein said membrane potential signals are produced by applying neurotransmitters or neuromodulators to the neuron or to the part of the neuron.

51. The method according to claim 42, wherein said membrane potential signals are produced by applying an electrical current to the neuron or to the part of the neuron.

52. The method according to claim 51, wherein the electrical current is applied as a pulsed current.

53. The method according to claim 51, wherein the electrical current is applied as a modulated current.

54. The method according to claim 51, wherein the electrical current is applied as a constant current.

55. The method according to claim 42, wherein said optically recording of the membrane potential signals of the neuron or the part of the neuron is conducted in vitro or in vivo.

56. The method according to claim 42, wherein said part of the neuron is selected from the group consisting of an axon, a dendrite, a fine dendrite, a dendritic spine, a soma, and subparts thereof.

57. The method according to claim 42, wherein said staining comprises pressure injection of the dye into the neuron or into the part of the neuron, extracellular profusion of the dye over the neuron or over the part of the neuron, addition of dye solids to the neuron or to the part of the neuron, or intracellular application of the dye into the neuron or into the part of the neuron.

58. The method according to claim 42, wherein said determining comprises locating spike initiation zones in the neuron or in the part of the neuron.

59. A method of detecting membrane potential signal changes in a population of cells, said method comprising:
providing a population of cells comprising at least two cells from a living organism;
staining the population of cells with a dye that is sensitive to fast cellular membrane potential signals and capable of generating nonlinear optical signals;
optically recording membrane potential signals in the population of cells using nonlinear microscopy to produce a high spatiotemporal resolution recording of electrical activity in the population of cells; and
determining changes of the membrane potential signals in the population of cells.

60. The method according to claim 59, wherein said nonlinear microscopy comprises second-harmonic generation microscopy, third-harmonic generation microscopy, fourth-harmonic generation microscopy, or fifth-harmonic generation microscopy.

61. The method according to claim 59, wherein said nonlinear microscopy comprises multiphoton excitation.

62. The method according to claim 59, wherein the dye is a styryl dye.

63. The method according to claim 59, wherein said membrane potential signals spontaneously occur or are stimulated to occur in the population of cells.

64. The method according to claim 59, wherein said optically recording of the membrane potential signals in the population of cells is conducted in vitro or in vivo.
